(19) United States
(12) Patent Application Publication
(10) Pub. No.: US 2024/0272971 A1
(43) Pub. Date: Aug. 15, 2024

(54) MONOLOTHIC APPLICATION TRANSFORMATION

(71) Applicant: INTERNATIONAL BUSINESS MACHINES CORPORATION, ARMONK, NY (US)

(72) Inventors: Jin XIAO, White Plains, NY (US); Saurabh SINHA, Danbury, CT (US); Anup KALIA, White Plains, NY (US); Maja VUKOVIC, New York, NY (US)

(21) Appl. No.: 18/167,403

(22) Filed: Feb. 10, 2023

(51) Int. Cl. G06F 9/54

(52) U.S. Cl. CPC G06F 9/548; G06F 9/541

(57) ABSTRACT

Methods, computer program products, and systems are presented. The method computer program products, and systems can include, for instance: examining a monolithic object oriented computer program, wherein the examining the monolithic object oriented computer program includes identifying that the monolithic object oriented computer program includes an inheritance chain of classes having a first class and a second class; and generating a distributed set of microservice partitions in dependence on the examining the monolithic object oriented computer program, wherein the generating the distributed set of microservice partitions includes performing the generating so that there is hosted in a first microservice partition of a distributed set of microservice partitions the first class and further so that there is hosted in a second microservice partition of the distributed set of microservices the second class.

### BACKGROUND

Embodiments herein relate generally to transformation of a monolithic object oriented computer program and specifically to transformation of a monolithic object oriented computer program into a distributed microservices application.

In a microservice architecture, different functions of an application can be performed by different “microservices”. Each microservice can communicate with one or more other microservice via at least one application programming interface (API).

In object oriented programming, classes can provide user-defined data types that act as templates for individual objects, attributes and methods. Objects can provide instances of a class created with specifically defined data. Objects can correspond to real-world objects or an abstract entity. Methods refer to functions that are defined inside a class that describe the behaviors of an object. Object variables represent the state of an object. Objects can include data stored in an object variables field. According to the principle of encapsulation in object oriented programming, information can be contained inside an object and only select information is exposed. According to the principle of abstraction in object oriented programming, objects only reveal internal mechanisms that are relevant for the use of other objects, hiding any unnecessary implementation code. According to the principle of inheritance in object oriented programming, classes can reuse code from other classes. Relationships and subclasses between objects can be assigned, enabling developers to reuse common logic while still maintaining a unique hierarchy. According to the principle of polymorphism in object oriented programming, objects can be designed to share behaviors and can take on more than one form. The program can determine which meaning or usage is necessary for each execution of that object from a parent class, reducing the need to duplicate code. A child class can thus be created, which can extend the functionality of the parent class.

US Publication No. 2019/0108067 sets forth a method that transforms a monolithic application into microservices. The method groups application classes and methods into clusters, each corresponding to a respective microservice. The method determines a number of function calls to and from each clustered class and method. The method presents processing options for at least the one of the clustered classes and the methods that has a maximum value for the number of functions calls. The options include: create a new cluster with the at least of the classes and the methods: merge the at least one of the classes and the methods into a different cluster: duplicate the at least one of the classes and the methods into clusters having caller or callee classes or methods; and remain the at least one of the classes and the methods. The method processes the at least one of the classes and the methods based on the user selected option.

US Publication No. 2022/0083334 sets forth technology for dividing a monolith computer program into a plurality of functions and creating a microservice for each function of the model's computer program. The micro-services are semantically and functionally equivalent, taken collectively, to the model's computer program from which they came. In some embodiments, the monolith computer program is written in an object oriented programming language suitable for execution by a virtual machine (VM).

### SUMMARY

Shortcomings of the prior art are overcome, and additional advantages are provided, through the provision, in one aspect, of a method. The method can include, for example: examining a monolithic object oriented computer program, wherein the examining the monolithic object oriented computer program includes identifying that the monolithic object oriented computer program includes an inheritance chain of classes having a first class and a second class; and generating a distributed set of microservice partitions in dependence on the examining the monolithic object oriented computer program, wherein the generating the distributed set of microservice partitions includes performing the generating so that there is hosted in a first microservice partition of a distributed set of microservice partitions the first class and further so that there is hosted in a second microservice partition of the distributed set of microservices the second class.

In another aspect, the method can include constructing object data of the first class in the first microservice partition, the constructing including allocating memory space of a runtime memory of the first microservice partition to the object data of the first class, and writing the object data to the allocated memory space of the runtime memory of the first microservice partition, wherein the method includes storing reference identifier for the object data of the first class in an object registry of the first microservice partition.

In another aspect, the method can include, in response to a call for construction of an object of the first class, constructing object data of the first class in the first microservice partition, and constructing object data of the second class in the second microservice partition, wherein the object data of the first class and the object data of the second class define the object of the first class, wherein the method includes receiving, within the first microservice partition a call on the object of the first class for an inherited method inherited from the second class, and responding to the call using the object data of the second class.

In another aspect, the method can include constructing object data of the first class in the first microservice partition, constructing object data of the second class in the second microservice partition, and constructing object data of a third class in the first microservice partition, wherein the object data of the first class, the object data of the second class, and the object data of the third class define a certain object, wherein the method includes for construction of the certain object, (a) a constructor of the first class within the first microservice partition constructing the object data of the first class and calling a proxy class constructor of the second class within the first microservice partition, (b) the proxy class constructor, without constructing object data, calling a constructor of the third class within the first microservice partition, and (c) the constructor of the third class constructing the object data of the third class.

In another aspect, a computer program product can be provided. The computer program product can include a computer readable storage medium readable by one or more processing circuit and storing instructions for execution by one or more processor for performing a method. The method can include, for example: examining a monolithic object oriented computer program, wherein the examining the monolithic object oriented computer program includes identifying that the monolithic object oriented computer program includes an inheritance chain of classes having a first class and a second class; and generating a distributed set of microservice partitions in dependence on the examining the monolithic object oriented computer program, wherein the generating the distributed set of microservice partitions includes performing the generating so that there is hosted in a first microservice partition of a distributed set of microservice partitions the first class and further so that there is hosted in a second microservice partition of the distributed set of microservices the second class.

In a further aspect, a system can be provided. The system can include, for example a memory. In addition, the system can include one or more processor in communication with the memory. Further, the system can include program instructions executable by the one or more processor via the memory to perform a method. The method can include, for example: examining a monolithic object oriented computer program, wherein the examining the monolithic object oriented computer program includes identifying that the monolithic object oriented computer program includes an inheritance chain of classes having a first class and a second class; and generating a distributed set of microservice partitions in dependence on the examining the monolithic object oriented computer program, wherein the generating the distributed set of microservice partitions includes performing the generating so that there is hosted in a first microservice partition of a distributed set of microservice partitions the first class and further so that there is hosted in a second microservice partition of the distributed set of microservices the second class.

Shortcomings of the prior art are overcome, and additional advantages are provided, through the provision, in one aspect, of a method. The method can include, for example: constructing object data of a first class in a first microservice partition; and constructing object data of a second class in a second microservice partition, wherein the second class and the first class are in inheritance class relation.

Shortcomings of the prior art are overcome, and additional advantages are provided, through the provision, in one aspect, of a method. The method can include, for example: receiving, by a certain class hosted on a first microservice partition, a call for construction of an object of the certain class, wherein the certain class is a child class of a parent class: in response to the receiving, constructing object data of the certain class on the first microservice partition and sending by the first microservice partition to a second microservice partition a call for construction of object data of the parent class; and constructing object data of the parent class on the second microservice partition in response to the call for construction of object data of the parent class, wherein the object of the certain class is defined by the object data of the certain class, and object data of the parent class.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system for transformation of a monolithic object oriented computer program according to one embodiment;

FIG. 2 depicts a transformation manager according to one embodiment:

FIG. 3 is a flowchart illustrating transformation of an object oriented computer program according to one embodiment:

FIG. 4 is a diagram illustrating transformation of an object oriented computer program according to one embodiment

FIG. 5 is a diagram illustrating transformation of an object oriented computer program according to one embodiment:

FIG. 6 is a diagram illustrating a microservice partition memory according to one embodiment;

FIG. 7 is a diagram illustrating transformation of an object oriented computer program according to one embodiment:

FIG. 8 is a diagram illustrating operation of an object oriented computer program transformed into a distributed set of microservice partitions according to one embodiment:

FIG. 9 is a diagram illustrating operation of an object oriented computer program transformed into a distributed set of microservice partitions according to one embodiment;

FIG. 10 is a diagram illustrating operation of an object oriented computer program transformed into a distributed set of microservice partitions according to one embodiment:

FIG. 11 is a diagram illustrating operation of an object oriented computer program transformed into a distributed set of microservice partitions according to one embodiment:

FIG. 12 is a diagram illustrating operation of an object oriented computer program transformed into a distributed set of microservice partitions according to one embodiment:

FIG. 13 depicts a computing environment according to one embodiment.

### DETAILED DESCRIPTION

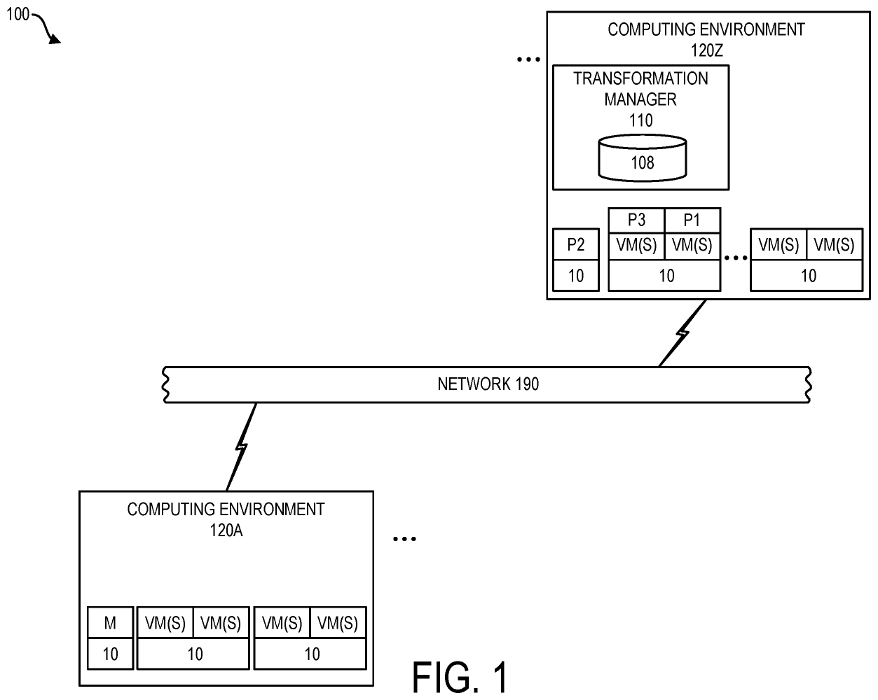

System 100 for use in transforming a computer program is illustrated in FIG. 1. System 100 can include one or more computing environment, e.g., computing environments 120A to 120Z, where “Z” can be any integer. Computing environments 120A to 120Z can include, e.g., computing nodes 10 provided by physical computing nodes, one or more of which may host at least one virtual machine (VM) such as a system virtual machine. System 100 can include numerous devices which can be computing node-based devices connected by network 190. Computing environments 120A to 120Z can be in communication with one another via network 190. Network 190 can be a physical network and/or a virtual network. A physical network can be, for example, a physical communications network connecting numerous computing nodes or systems such as computer servers and computer clients. A virtual network can, for example, combine numerous physical networks or parts thereof and illogical virtual networks. In another example, numerous virtual networks can be defined as a single physical network.

In one embodiment, system 100 can include one or more transformation manager 110. Transformation manager 110 can include data repository 108. Transformation manager 110 can be configured to manage the transformation of a computer program which monolithic computer program can be provided by a monolithic object oriented based computer program.

Transformation manager 110 can manage the transformation of a monolithic object oriented computer program into a distributed microservices application in which functions of the monolithic object oriented program are transformed into functions performed by a set of microservices provided by one or more microservice. The set of microservices can be semantically and functionally equivalent to the monolithic object oriented computer program subject to transformation. Transformation manager 110, in FIG. 1, is shown as being hosted by computing environment 120Z, but alternatively, can be hosted by computing environment 120A and/or computing environment 120A and all computing and/or computing environment 120Z.

In one aspect, with reference to FIG. 1, system 100 can be used to re-host a monolithic object oriented program hosted on a first computing environment, e.g., computing environment 120A, into a second computing environment, e.g., computing environment 120Z. As shown in FIG. 1, there can be hosted in computing environment 120A monolithic object oriented application M. In one example, transformation manager 110 can transform and re-host the monolithic application object oriented application M into computing environment 120Z. In the described example of FIG. 1, monolithic object oriented application M can be re-hosted in computing environment 120Z as a distributed microservices based application having microservice partitions P1, P2, and P3.

In one use case example, computing environment 120A can be provided, e.g., by a private enterprise network. Computing environment 120Z, in one example, can include one or more feature characterizing a cloud computing environment as set forth in the NIST definition of cloud computing, US Department of Commerce, September 2011. Computing environment 120Z can be provided, e.g., by a data center such as an edge network, core network, or data network data center. Computing environment 120Z, in one example, can be a public multi-tenancy computing environment.

While embodiments herein envision rehosting of a monolithic object oriented computer program M on an external computing environment, embodiments herein can commonly re-host a monolithic object oriented computer program on the computing environment of the monolithic object oriented computer program.

In one particular use case, transformation manager 110 can be used in the development of a microservices based application. For example, a developer developing a microservices based application can write monolithic object oriented computer program M, and input the same for processing by transformation manager 110. Transformation manager 110 can output as a result a microservices based application performing the function of the monolithic microservices based computer program.

Embodiments herein recognize that transformation of a monolithic object oriented computer program into a microservices-based application can provide various advantages. In one aspect, the described transformation can improve reliability. For example, if a single function of an application is to be revised, the revision can be performed without interruption of a running application. Rather, a revision can be performed by revising a single microservices application. When a newly revised microservice has been updated, it can be placed in communication with the remaining microservices defining an application and a prior microservice can be decommissioned. The microservice architecture can enable more agile development because each microservice is independently developable and deployable. Microservices-based architecture can provide an enhanced set of options for hosting. For example, referring to FIG. 1, the first microservice of a first partition can be hosted on the system virtual machine VM(s) and a second microservice of a second partition P2 can be hosted on a computing node 10 which can be provided by a physical computing node. A microservices architecture by way of an enhanced range of logging agents can also provide an enhanced inability to identify potential problems in a running application.

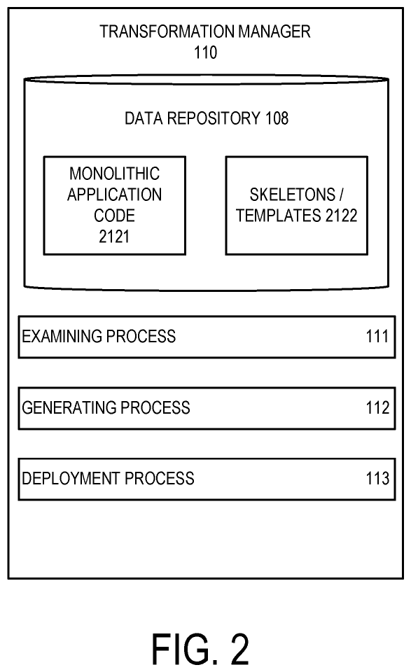

As shown in FIG. 2, transformation manager 110 can include data repository 108 and can run various processes, including examining process 111, generating process 112, and deployment process 113. Data repository 108 of transformation manager 110 can store various data. In monolithic application code area 2121 of data repository 108, data repository 108 can store monolithic application code that defines a monolithic object oriented computer program. In one example, transformation manager 110 can pull monolithic application code defining a monolithic object oriented program from a first computing environment for storage of the monolithic application code to facilitate examination of monolithic object oriented computer program.

In skeletons/templates area 2122, data repository 108 can store skeletons and/or templates for use in generating code defining a microservices-based application. A skeleton can refer to a class definition. A code template can be provided by a model or prototype of the Java code to be generated for proxy and service classes. It can be expressed in a templating language and can be implemented using programming constructs of the templating language together with Java code. One embodiment can employ the Jinja templating language, but, alternatively, other templating languages could be used. A code-generation process can take a code template and transform it into executable Java code by rendering it through a templating engine. In this manner, executable code in the Java language for proxy classes and the service classes for each microservice partition can be provided.

Transformation manager 110 can run various processes. Transformation manager 110 running examination process 111 can include transformation manager 110 examining a monolithic object oriented computer program. Transformation manager 110 running examination process can include transformation manager 110 running a static text-based process in which transformation manager 110 examines text-based code of monolithic application code for return of monolithic object oriented program code attributes. Transformation manager 110 running examining process 111 can include transformation manager 110 performing a runtime process in which transformation manager 110 runs monolithic application code defining a monolithic object oriented computer program and examining logging data. e.g., call data for return of attributes respecting the monolithic object oriented computer program.

Transformation manager 110 running generating process 112 can include transformation manager 110 generating microservices. Transformation manager 110 running generating process 112 can include transformation manager 110 generating code defining a set of microservices performing functions of a monolithic object oriented computer program subject to examining. Transformation manager 110 running generating process 112 can run a microservices code generating pipeline as set forth herein.

Transformation manager 110 running deployment process 113 can deploy an application defined by a set of microservices as defined by code generated by generating process 112. Transformation manager 110 running deployment process 113 can include transformation manager 110 deploying a microservices based application on the same computing environment hosting a monolithic object oriented computer program subject to transformation and/or can include transformation manager 110 deploying a microservices based application on a computing environment different from a computing environment hosting a monolithic object oriented computer program subject to transformation.

In one aspect, monolithic object oriented computer program M of computing environment 120A can include classes that are in inherited class relation. System 100 as shown in FIG. 1 can be configured so that classes in inherited class relation of a monolithic object oriented computer program M remain functional after being subjected to transformation with different classes in inheritance class relation being distributed into different microservice partitions.

According to methods herein, classes that are in inheritance relation to one another, can be distributed into different hosting microservice partitions with the microservice partitions being provisioned so that calling of a constructor of a non-root class results in an object of the non-root class being constructed and constructors of all parent classes being called and object data of all parent classes being constructed. With the object data of all parent classes being constructed, the microservice partitions can be provisioned so that a proxy class of the non-root class can handle service calls for parent class methods.

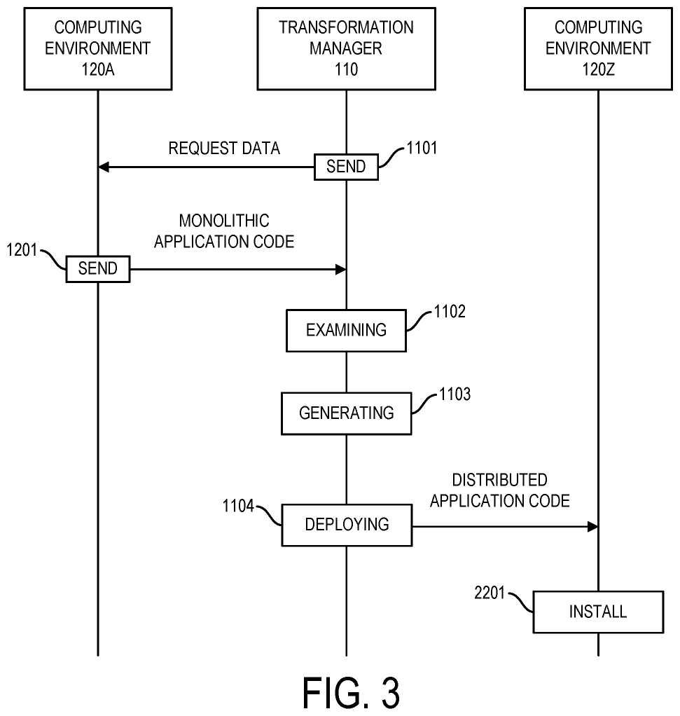

FIG. 3 illustrates transformation manager 110 interoperating with computing environment 120A hosting a monolithic object oriented computer program in computing environment 120Z which, in one example, can serve as the target computing environment for hosting a generated microservices-based application resulting from subjecting the described monolithic object oriented program to transformation processes herein. Transformation manager 110 in FIG. 1 is shown as being hosted by computing environment 120Z, but alternatively can be hosted by computing environment 120A and/or computing environment 120A and in one embodiment, each computing environment of computing environments 120A to 120Z.

At block 1101, transformation manager 110 can send request data to computing environment 120A. On receipt of the request data, computing environment 120A at block 1201 can send monolithic application code defining a monolithic object oriented computer program M subject to transformation to transformation manager 110. On receipt of the monolithic application code sent at block 1201, transformation manager 110 can store the received monolithic application code in monolithic application code area 2121 of data repository 108.

On the performance of such storing, transformation manager 110 at block 1102 can perform examining of the received monolithic application code. The examining of block 1102 can include static examining in which transformation manager 110 performs text-based analysis of text-based code defining the monolithic application code sent at block 1201. In one example of static examining, examining at block 1102 can include examining a feature vector of words in the application code (e.g., the names of classes), committer or maintainer information, and/or security levels. The committer or maintainer information can include, for example, the name of the committer or maintainer: the organization of the committer or maintainer, commit data for the application, and so forth.

The examining at block 1102 can also include runtime examining. For a performance of runtime examining, transformation manager 110 at block 1102 can run the monolithic application code sent at block 1201 and can examine logging data for return of attributes defining the monolithic application code sent at block 1201. In one aspect, runtime examining can include analyzing a call graph that includes information about a number of function calls in the monolithic operation, the classes and/or objects associated with such calls, and timing of such calls. Examining at block 1102, in some embodiments, can include “human in the loop” processing wherein human input response data, e.g., to menu driven questions is processed. A developer can be requested to specify, e.g., whether, for a specific class, to (A) create a new microservice partition with this class or method: (B) merge this class or method into another microservice partition: (C) duplicate this class or method into all the microservice partitions that have caller or callee classes or methods; and (D) remain this class or method in the current microservice partition.

Based on the examining at block 1102, transformation manager 110 can determine that multiple classes of the monolithic object oriented program are in inheritance class relation, and that advantages would result from distributing at least first and second ones of the multiple classes so that the first and second ones of the multiple classes are hosted in respective first and second microservices partitions.

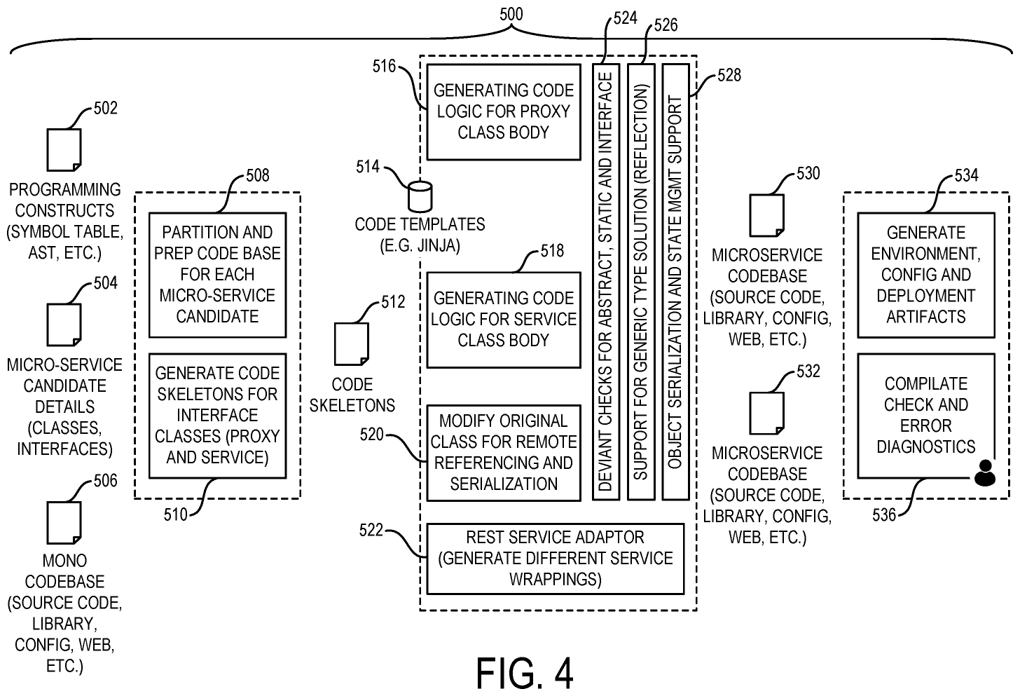

On completion of examining at block 1102, transformation manager 110 can proceed to generating block 1103. At generating block 1103, transformation manager 110 can generate microservices. Generating microservices at block 1103 can include generating code defining the set of distributed microservices performing the functions of the monolithic object oriented program M subject to transformation. Generating at block 1103 can include execution of the code generating pipeline described in reference to FIG. 4.

An API (application programming interface) generation pipeline is shown by diagram 500 of FIG. 4. Diagram 500 can include: programming constructs block 502: micro-service candidate block 504; mono codebase block 506: partition and prep code block 508: generate code skeletons block 510; code skeletons block 512; code templates block 514; proxy class block 516; service class block 518: remote referencing block 520; REST (representational state transfer) adaptor block 522: deviant checks block 524: generic solution block 526; object serialization block 528; first microservice codebase block 530; second microservice codebase block 532; generate environment block 534; and compilate check block 536.

The inputs to the pipeline of diagram 500 can include, e.g.: (i) the code base for the monolithic application (source code, libraries used, and configuration files) (see block 502); (ii) microservice candidate details (including information about partitions of classes and interface classes for each partition) (see block 504); and (iii) meta information about the monolithic application, including the symbol table, class and function declarations and signatures, and abstract syntax trees (see block 506).

The output of the pipeline of diagram 500 can include: (i) generated code for proxy and service classes for each partition (see blocks 530 and 532); (ii) some modified classes of the monolithic application (see blocks 530 and 532), and (iii) generated build, configuration, and deployment artifacts (see blocks 530 and 532). In the transformed, microservice-based application produced by the pipeline. API-driven communication occurs across partitions (which occurred as Java method calls in the monolith version), while preserving the language-level semantics of the monolithic object oriented computer program subject to transformation.

The first stage of the pipeline of diagram 500 can initialize the code base for each microservice partition and can generate code skeletons for interface classes of each partition (see blocks 508, 510 and 512). Interface classes herein can refer to classes that can be shared between microservice partitions.

The second stage of the pipeline, represented by blocks 516, 518, 520, 522, 524, 526, and 528, can perform code generation for proxy and service classes. This stage can take as input the code skeletons created in the previous stage discussed in the previous paragraph. To generate code for a proxy/service class, this stage can use a set of code templates. A code template can include a model or prototype of the Java code to be generated for proxy and service classes. It is expressed in a templating language and is implemented using programming constructs of the templating language, together with Java code. One embodiment can use the Jinja templating language, but, alternatively, other templating languages could be used.

The code-generation process can take a code template and transform it into executable Java code by rendering it through a templating engine. In this manner, the second stage generates executable code in the Java language for the proxy classes and the service classes for each microservice partition. Operations of the second stage can also modify some of the original monolith classes to enable referencing of remote objects in a partition. Additionally, the second stage can generate supporting/utility Java classes that facilitate serialization and deserialization of method call parameters for enabling communication across partitions, based on dynamic checking of parameter types. The communication across partitions can be performed by communications of computer code that are formed and formatted to work with REST APIs (herein sometimes referred to as “REST API communication”). Thus, the code generator can generate appropriate service and client code to enable REST API communication, and different service wrappings for REST API communication, corresponding to different Java libraries for REST, can be employed. Finally, the second stage of the pipeline: (i) can perform various checks on interface classes and the parameters of their methods to ensure that the transformation has preserved semantics as used in the original monolith style program; and (ii) also can identify parts of the code that may need to be manually updated by developers (for example, in some embodiments, these parts of the code are highlighted in a visual display of the code so that human individual developers can easily locate them).

The third and final stage of the pipeline at blocks 534 and 536 of diagram 500: (i) can perform compilation checks on the generated code to ensure that the code is syntactically correct; and (ii) can generate build, configuration, and deployment artifacts for each microservice partition so that the partition can be deployed as an independent microservice.

Referring back to FIG. 3, on performance of the generating at block 1103, transformation manager 110 can proceed to block 1104. At block 1104, transformation manager 110 can perform deploying of the generated code defining the set of microservices generated at block 1103. Transformation manager at block 1104 can send application code defining distributed microservices to targeted hosts of the targeted computing environment, e.g., computing environment 120Z in the exemplary embodiment, e.g., which can include physical host nodes and/or virtual host nodes. On receipt of the distributed microservices application code, the various host nodes of computing environment 120Z, via appropriate code installers, can perform installation of the various defined microservices at block 2201.

Embodiments herein set forth to preserve the described functional characteristics of inheritance with the transformation of a monolithic object oriented computer program into a set of distributed microservices. Embodiments herein preserve the functionality of an object oriented program code with inherited classes where classes defining a set of inherited classes can be distributed into different microservices.

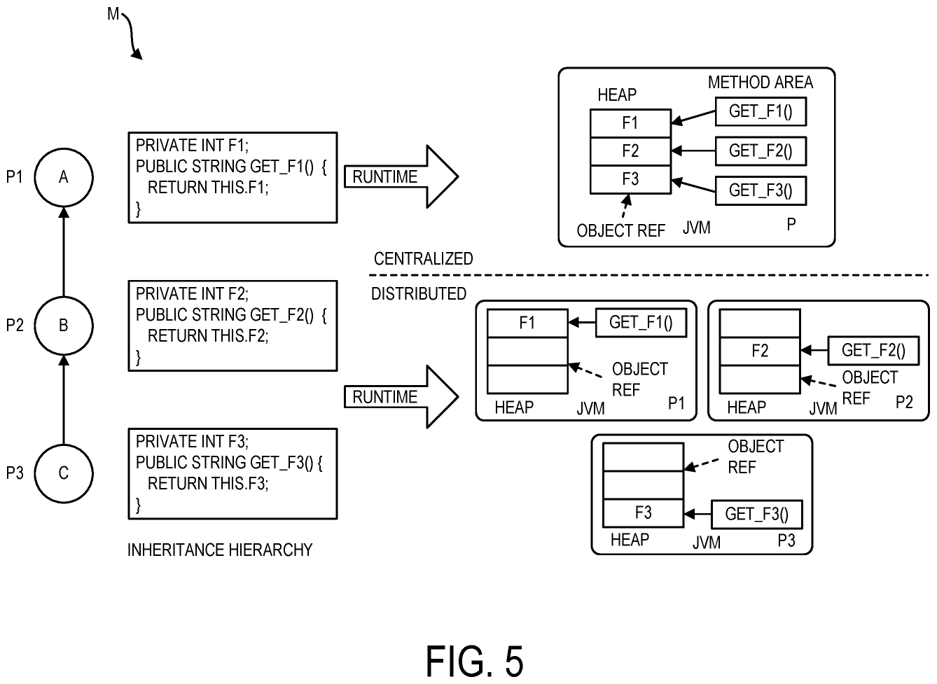

Referring to FIG. 5, monolithic object oriented computer program M can include classes A, B, and C that are in inherited class relation. In the described example of FIG. 5, class A is the parent class of class B and class B is the parent class of class C. Certain variables can be associated to each class. Class A can include the variable f1, class B can include the variable f2, and class C can include the variable f3. Various methods can be associated to each class. For example, an object of class A can run the method “get_f1( )”, an object of class B can run the method “get_f2( )”, and an object of class C can run the method “get_f3( )”. According to principles of object inheritance in object oriented programming, a child class can inherit all of the methods of its parent classes. Accordingly, with adherence to the principle of inheritance, an object of class C as set forth in FIG. 5, can service a call for the described method “get_f3( )” (a method of C), and in addition, can service a call for the method “get_f2( )” (a method of class B), and can further service a call for the method “get_f1( )” (a method of class A).

In one embodiment, a monolithic object oriented computer program can be implemented in Java. Embodiments herein recognize that when an object is created in Java, a Java Virtual Machine (JVM), the JVM can allocate an object to a heap memory space. Variables and methods associated to a class can object and can be written to a heap.

In one aspect, transformation manager 110 can transform a monolithic object oriented computer program M so that functionality of inherited classes is preserved, even where physical classes in inheritance relation are disposed in first and second different microservice partitions. Embodiments herein recognize that constraining classes in inheritance relation to reside in a common microservice partition can create coarse microservice partitions, each containing many classes and different functionalities. In degenerate cases, such constraining can create “monolithic partitions”, reducing the effectiveness of microservice decomposition. To address the referenced problems, embodiments herein can provide distributing inheritance relations across microservice partitions in a manner that preserves the semantics of centralized inheritance: i.e., with respect to (a) object creation, (b) constructor chaining, (c) object state reads/updates, (d) dynamic dispatch, (e) reference parameter passing, and/or (f) garbage collection.

A runtime instance P of monolithic object oriented computer program M is illustrated in FIG. 5. When a constructor of class C is called, the constructor of class C constructs an object of type C and intrinsically calls the constructor of its superclass, class B. The constructor of class B in turn constructs an object of type B and intrinsically calls the constructor of class A. The constructor of class A can construct an object of type A. For construction of an object a runtime environment, e.g., a Java virtual machine (JVM) can allocate memory space of a runtime memory to the object. Object variable defining data (defining a state of an object) and object method defining data can be written from a class loader to the allocated memory space of the runtime memory. All objects of an inheritance chain of objects can be written to a common runtime memory.

In a transformed application transformed by transformation manager 110 where functions of a monolithic object oriented computer program are transformed into a distributed set of microservice partitions P1, P2, P3 (FIG. 5), there can be different runtime memories for different object data associated to respective classes that are of a common inheritance chain of classes. In the described example of FIG. 5, object data constructed by calling a constructor of class A can be written to an allocated memory space of a runtime memory of microservice partition P1, object data constructed by calling a constructor of class B can be written to an allocated memory space of a runtime memory of microservice partition P2, and object data constructed by calling a constructor of class C can be written to an allocated memory space of a runtime memory of microservice partition P3. In one example, the different microservice partitions P1, P2, and P3 can be running on different computing nodes 10 provided by physical computing nodes having different runtime memories that can be defined on different memory devices of the different computing nodes 10.

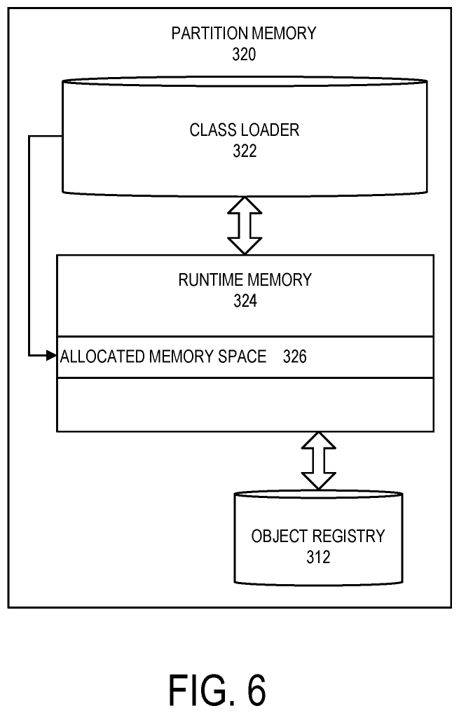

FIG. 6 is a diagram illustrating operations of a physical class constructing class object data with reference to a microservice partition memory 320 having a class loader 322, a runtime memory 324, and an object registry 312. For constructing object data, a physical class can allocate memory space 326 (which can shift/move in runtime) of runtime memory 324 to the object data, and the physical class can write object data stored in class loader 322 into the allocated memory space 326 of the runtime memory 324. The object data can include variable defining object data and method defining object data. With the object data written to the allocated memory space 326, the physical class can register itself with partition manager 310 and can generate a reference identifier for the constructed object data. The reference identifier can define a pointer to the constructed object data written to the described allocated memory space of runtime memory 324.

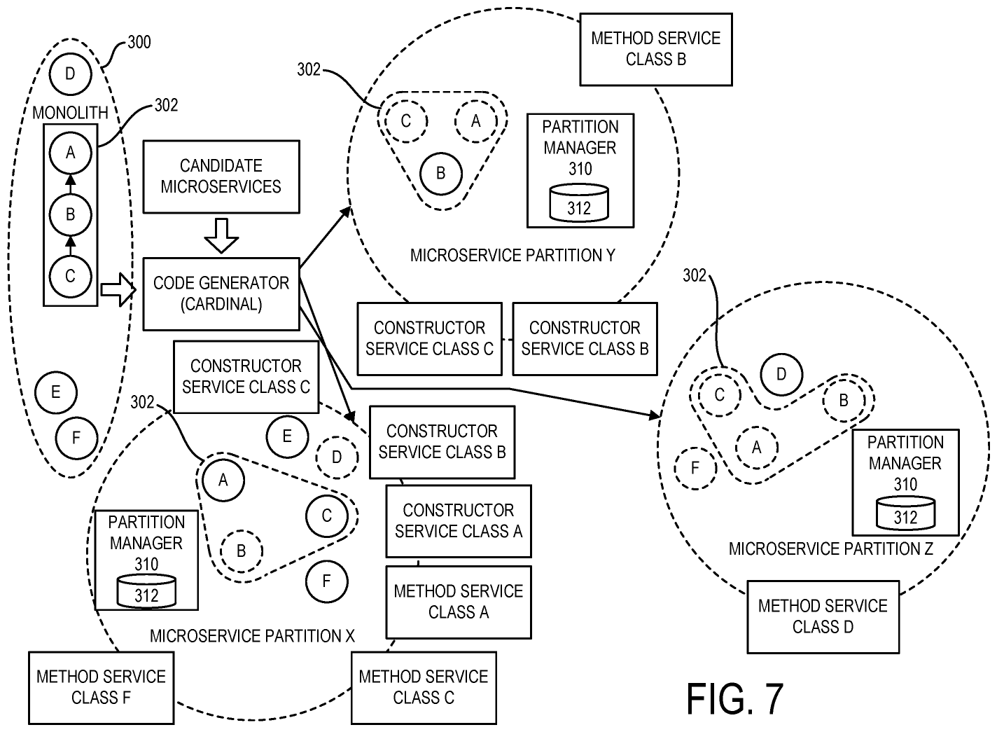

FIG. 7 illustrates transformation of monolithic object oriented computer program 300 into a distributed set of microservices including microservice partition X, microservice partition Y and microservice partition Z. Monolithic object oriented computer program 300 can include an inheritance chain of classes 302 comprising parent class A, child class B, and grandchild class C. Monolithic object oriented computer program 300 can also include classes D, E, and F which are independent classes not included in any inheritance chain of classes.

For transformation of a monolithic object oriented application, each class of the set of classes of monolithic object oriented computer program 300 can be hosted on one microservice partition of the set of microservices comprising microservice partition X, microservice partition Y, and microservice partition Z. Where a microservice partition hosts a certain class, that microservice partition can construct object data of the certain class. Constructing object data of a certain class can include allocating runtime memory space for variables and/or methods of the certain class. Constructed object data can include object data defining one or more object variable and/or one or more object method. Where a certain class is hosted in a certain microservice partition, the certain microservice partition can be said to include a physical class of the certain class.

In the described example of FIG. 7, class A can be hosted in microservice partition X, class B can be hosted in microservice partition Y, class C can be hosted in partition X, class D can be hosted in microservice partition Z, class Z can be hosted in microservice partition E, and class F can be hosted in microservice partition X.

The various microservice partitions in the described example can also include proxy classes. Proxy classes of a certain type can provide access to methods of classes other than the certain type.

In the described example of FIG. 7, microservice partition X can include proxy class B, microservice partition Y can include proxy class A and proxy class C, and microservice partition Z can include proxy class A, proxy class B, and proxy class C.

In another aspect, inheritance chain of classes 302 of monolithic object oriented computer program 300 can be provided as a combination of physical and proxy classes in one or more microservice partition. In microservice partition X, inheritance chain of classes 302 can be provided as the combination of classes A, B, and C where class A and C are provided as physical classes and class B is provided as a proxy class. In microservice partition Y, class B is provided as a physical class and class A and class C are provided as proxy classes. In microservice partition Z, class A, class B, and class C are provided as proxy classes.

In the distributed set of microservices provided by microservice partition X, microservice partition Y and microservice partition Z can include one or more constructor service class. Constructor service classes can facilitate the construction of object data of classes defining an inheritance chain of classes where a call for construction of an object is made on a child class of an inheritance chain of classes. According to a principle of inheritance in object oriented programming, a call for construction of an object on a constructor of a child class of an inheritance chain of classes intrinsically results in a call for construction of object data of all parent classes of the child class.

For example, with reference to FIG. 5, a call for construction of an object of class C can result in a constructor of class C intrinsically calling class B for the construction of an object data of class B and a constructor of class B intrinsically calling a constructor of class A for the construction of object data of class A. The construction of object data of parent class provisions an object of a child class so that the object of the child class can respond to calls for methods inherited from a parent class.

According to code provisioning rules that can be implemented by generating process 112, various microservice partitions in a set of generated microservice partitions can include one or more constructor service class. In one embodiment, there can be provisioned in a microservice partition a constructor service class for a class that is included in a chain of inheritance-related classes where (a) there is a physical class for the inheritance chain in the microservice partition of equal or greater hierarchy, and (b) there is provisioned one or more of a proxy or physical class for the certain class in a microservice partition external to the certain microservice partition.

In the described example of FIG. 7, there can be provisioned for microservice partition Y, constructor service class A based on the presence of physical class B in microservice partition Y and the presence of physical class C in microservice partition X. The provisioning of constructor service class C in microservice partition Y can alternatively be based on the presence of physical class B in microservice partition Y and on the presence of proxy class C in microservice partition Z.

There can be provisioned in microservice partition Y constructor service class B based on the presence of physical class B in microservice partition Y and on the presence of proxy class B in microservice partition X. The provisioning of microservice partition Y to include constructor service class B can alternatively be based on the presence of physical class B in microservice partition Y and on the presence of proxy class B in microservice partition Z.

Regarding microservice partition X, microservice partition X can be provisioned to include constructor service class C based on microservice partition X having at least one of physical class C or physical class A and there being proxy class C in microservice partition Y. Alternatively, microservice partition X can be provisioned to include constructor service class C based on there being at least one of physical class C or physical class A in microservice partition X and there being proxy class C in microservice partition Z.

Microservice partition X can also include constructor service class B. Microservice partition X can be provisioned to include constructor service class B based on there being physical class A in microservice partition X and further based on there being proxy class A in microservice partition Y. Alternatively microservice partition X can be provisioned to include constructor service class B based on there being physical class A in microservice partition X and based on there being proxy class A in microservice partition Z.

Microservice partition X can be provisioned to include constructor service class A based on there being physical class A and microservice partition X and based on there being proxy class A in microservice partition Y. Alternatively, microservice partition X can be provisioned to include constructor service class A based on there being physical class A in microservice partition X and based on there being proxy class A in microservice partition Z.

The described constructor service classes can facilitate the construction of an entire inheritance chain such as inheritance chain 302, wherein different physical classes defining the inheritance chain, e.g., inheritance chain 302, are distributed into different microservice partitions.

Various distributed microservice partitions X, Y, and Z depicted in FIG. 7 can also include method service classes. By rules that can be implemented by generating process 112, various microservice partitions as shown in FIG. 7 can include method service classes that provide access to physical class object data from an external microservice partition.

Referring to FIG. 7, a microservice partition can be provisioned to include a method service class for a certain class where there is a physical class of the certain class in the microservice partition that is accessed by an external microservice partition. In the described example of FIG. 7 and referring to microservice partition X, there can be provisioned method service class A in microservice partition X based on there being physical class A hosted in microservice partition X and based on there being a proxy class for class A and at least one of microservice partition Y or microservice partition Z. Such proxy classes for class A are included in both microservice partition Y and microservice partition Z in the described example.

There can be provisioned microservice class C in microservice partition X based on there being physical class C in microservice partition X and based on there being a proxy class for class C in at least one of microservice partition Y and microservice partition Z. There are such proxy classes for class C in both in the described example. There can be provisioned in microservice partition X method service class F based on there being physical class F in microservice partition X and based on there being proxy class F in microservice partition Z.

There can be provisioned method service class B in microservice partition Y based on there being physical class B provisioned within microservice partition Y and based on there being a proxy class for class B in at least of one of microservice partition X or microservice partition Z.

There can be provisioned method service class D in microservice partition Z based on there being physical class D provisioned within microservice class D and based on there being a proxy class for class D in microservice partition X.

Each microservice partition X, Y, and Z can include a respective partition manager 310. Partition manager 310 can run various processes, such as assigning reference identifiers to constructed object data. The respective partition managers 310, on the construction of object data, can store references to object data in an object registry 312. For construction of object data, a constructor of a physical class can allocate memory space of a runtime memory for the object data which object data can include object data defined by one or more variable and object data defined by one or more method. On construction of object data within a certain microservice partition, partition manager 310 can store in object registry 312 of the certain microservice partition a reference for the object data. The reference can include a reference ID and can define a pointer to the object data residing on the allocated memory space of the certain microservice partition's runtime memory. In a Java virtual machine (JVM), object data defining object variables and object methods can be stored in a runtime memory space known as a heap.

Partition manager 310 can store various additional data. For example, each partition manager 310 can store data that specifies the physical classes, the proxy classes, the constructor service classes, and method service class associated to each respective microservice partition, e.g., microservice partition X, microservice partition Y, and microservice partition Z in the described example. Embodiments herein can include microservice partitions sharing object data references between microservice partitions. The sharing of object data references between microservice partitions can provide access to object data between microservice partitions. An object data reference herein for certain object data can define an object reference for an object defined by the certain object data.

Where an object is partially defined by object data constructed on a first microservice partition and partially defined by object data constructed on a second microservice partition, a service call for an object method can be initiated on the first microservice partition. Responsively, the first microservice partition can call the second microservice partition for access to object data constructed on the second microservice partition using a common reference identifier that commonly references the object data constructed on the first microservice partition and the object data constructed on the second microservice partition. The various microservice partitions X, Y, and Z can include appropriate respective application programming interfaces (APIs) having addressable API endpoints to facilitate communication with the respective microservice partitions. In one embodiment, the APIs facilitating communication between microservice partitions can be provided by representational state transfer (REST) APIs. In one embodiment, the APIs can include use of a microservices message bus that facilitates communication between the various microservice partitions.

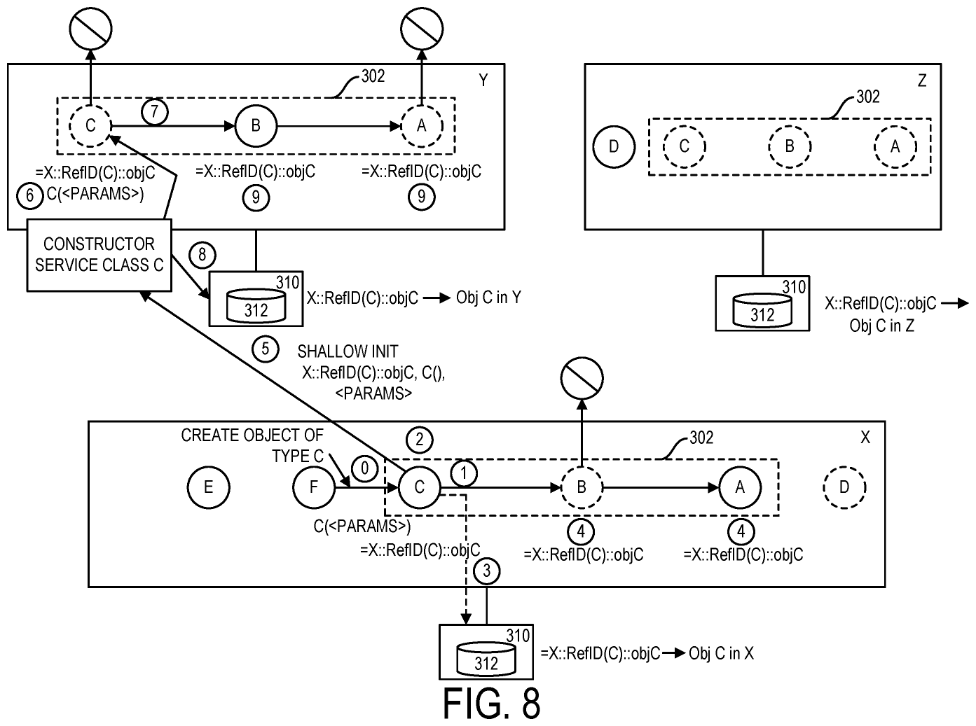

Various additional features associated to the provisioning of the set of microservices are set forth in reference to FIGS. 8-10. FIG. 8 illustrates a method of using the set of microservices provisioned as set forth in FIG. 7. Referring to FIG. 8 at (0), there can be a call to a constructor of physical class C for construction of an object of type C. At (1), in response to the described call of the constructor of class C, physical class C can call the appropriate shallow constructor of proxy class B within microservice petition X. The shallow constructor of proxy call B can perform the limited action of calling a parent class constructor (the constructor of physical class A in partition X), but can avoid constructing variable and method defining object data for support of service calls.

At (2), the constructor of class C can construct object data of type (C). For construction of class C object data at (2), physical class C can perform state initialization as coded in the original constructor definition. Physical class C can allocate runtime memory space of microservice partition X, can constructed object data, and can write object data of a class loader to the allocated memory space of the partition runtime memory. The constructed object data can include variable defining object data and/or method defining object data.

At (3), physical class C can register itself with partition manager 310, which partition manager 310 can generate a reference ID for the constructed object data defining object C for storage in the object registry 312. The reference ID for the constructed object data of type C can be given as RefID(C). The stored reference ID, RefID(C) for the object of type C, can define a pointer for an allocated memory space location of microservice partition X at which the constructed class C object data constructed at (2) is stored. FIG. 6 is a diagram illustrating operations of a physical class constructing class object data with reference to a microservices partition memory 320 having a class loader 322, a runtime memory 324, and an object registry 312. For constructing object data, a physical class can allocate memory space 326 (which can shift/move in runtime) of runtime memory 324 to the object data, and the physical class can write object data stored in class loader 322 into the allocated memory space 326. The object data can include variable defining object data and method defining object data. With the object data written to the allocated memory space 326, the physical class can register itself with partition manager 310 and partition manager 310 can generate a reference ID for the constructed object data.

As set forth herein, reference IDs for constructed object data can be passed between microservice partitions. On receipt of a reference ID specifying a memory space storage location for an object, a receiving microservice partition can apply the reference ID in its own microservice partition, thus replicating the name space of the sending microservice partition. Sending and receiving microservice partitions (e.g., X and Y in FIG. 8) can have separate runtime memories (possibly on different memory devices) but with the distribution of reference IDs can include replicated name spaces defining pointers to object data of a runtime memory.

In the scenario depicted in FIG. 8, calling of a constructor of object C can result in object data for class C being constructed and physical constructors of class B and A being called for construction of class B object data and class A object data. Object C can be defined by the combination of class C object data, class B object data, and class A object data. With object C constructed, object C can service method calls for methods inherited from any parent class.

At (4), the constructor of proxy class B, in response to being called at (1) by the constructor of physical class A, can call the constructor of physical class A. In the described scenario, the calling of the constructor of proxy constructor B at (1), with class B being a proxy class in microservice partition, does not result in object data of class B being constructed. However, the calling of the constructor of physical class C at (4) with physical class C being a physical class does result in object data of class C being constructed. For construction of class A object data at (4), physical class A can perform state initialization as coded in the original constructor definition, memory space of microservice partition X can be allocated for the constructed object data, and object data can be written to the allocated memory space. The constructed object data can include variable defining object data and/or method defining object data. At (4), the reference ID set for the new object of type C, can be set for all parent classes. With class A object data referenced to the reference RefID(C), class A object data can be accessed for performance of method service calls with use of the assigned object data reference.

At (5), the constructor of physical class C of microservice partition X can call constructor service class C of microservice partition Y with appropriate parameters and a RefID(C) to initiate a constructor chain in microservice partition Y. In response to the calling of the constructor service class C of microservice partition Y actions, (7), (8), and (9) can be performed as follows.

At (7), proxy class C of microservice partition Y can call the constructor of physical class B of microservice partition Y. On the calling of proxy class C, object data of class B can be constructed. For construction of class C object data at (7), physical class C can perform state initialization as coded in the original constructor definition, memory space of microservice partition Y can be allocated for the constructed object data, and object data can be written to the allocated memory space of the runtime memory of microservice partition Y. The constructed object data can include variable defining object data and/or method defining object data.

At (8), constructor service class C can add the reference identifier, RefID(C) to object registry 312 of microservice partition Y for the constructed object data of class C constructed at (1) and passed to microservice partition Y at (5) to the object registry 312 of partition Y.

At (9) the constructor for physical class B on construction of the described object data for class B be assign the referenced identifier RefID(C), added to object registry 312 of microservice partition Y at (8) to the constructed object data of class C. The assigned reference ID can serve as a pointer to the constructed object data of class B constructed at (7). With class B object data referenced to the reference identifier RefID(C), class B object data can be accessed for performance of method service calls on a constructed object of type C (defined by the combination of constructed class C object data, constructed class B object data, and constructed class A object data) with use of the assigned object data reference identifier.

By the described functionality, the constructor of physical class B constructs object data of class B and assigns (by registration with partition manager 310 of microservice partition Y) the reference identifier RefID(C) to the constructed object data of class B, wherein the reference identifier is the same reference identifier for constructed object data of class C passed from microservice partition X at (5)), and wherein the reference identifier defines a pointer to a runtime memory space location of the constructed class B object data of microservice partition Y. At (9), the RefID can be set in all parent classes.

By actions (0)-(9), an object of type C can be constructed with object data (class C and A object data) defining the object located on a runtime memory space location of microservice partition X and object data (class B object data) defining the object partially stored on a memory space of microservice partition Y. The different runtime memory space locations for microservice partition X and microservice partition Y can be defined on different memory devices, such as different memory devices associated with first and second different computing nodes 10 defined by physical computing nodes.

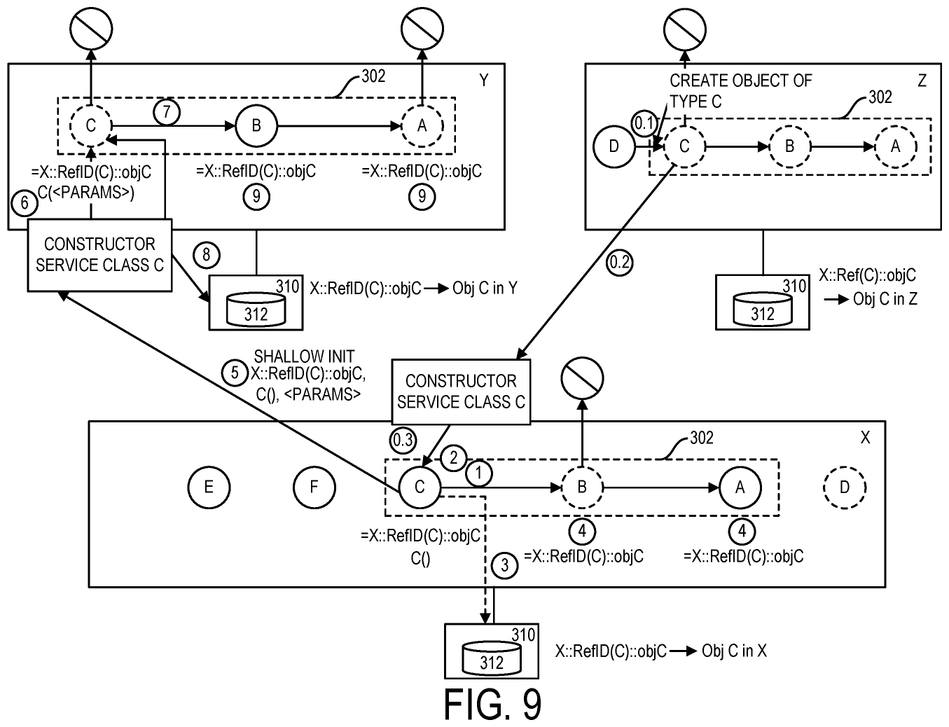

FIG. 9 illustrates operations of the microservice partitions X, Y, and Z, where a call for construction of object C is made on a proxy class C. At (0.1), a call for construction of an object of type C can be made on proxy class C of microservice partition Z. Responsively to the call at (0.1), proxy class C at (0.2) can call the constructor service class C of microservice partition X. Responsively to the call at (0.2), the constructor service class of microservice partition X at (0.3) can call the constructor of physical class C of microservice partition X to construct object data of class C. At (1), in response to the described call of the constructor of class C, physical class C can call the appropriate shallow constructor of proxy class B within microservice petition X.

At (2), the constructor of physical class C can construct object data of type (C). For construction of class C object data at (2), physical class C can perform state initialization as coded in the original constructor definition, memory space of microservice partition X can be allocated for the constructed object data, and object data can be written to the memory space. The constructed object data can include variable defining object data and/or method defining object data. Actions (1)-(9) in the scenario depicted in FIG. 9 can proceed in the manner depicted in FIG. 8.

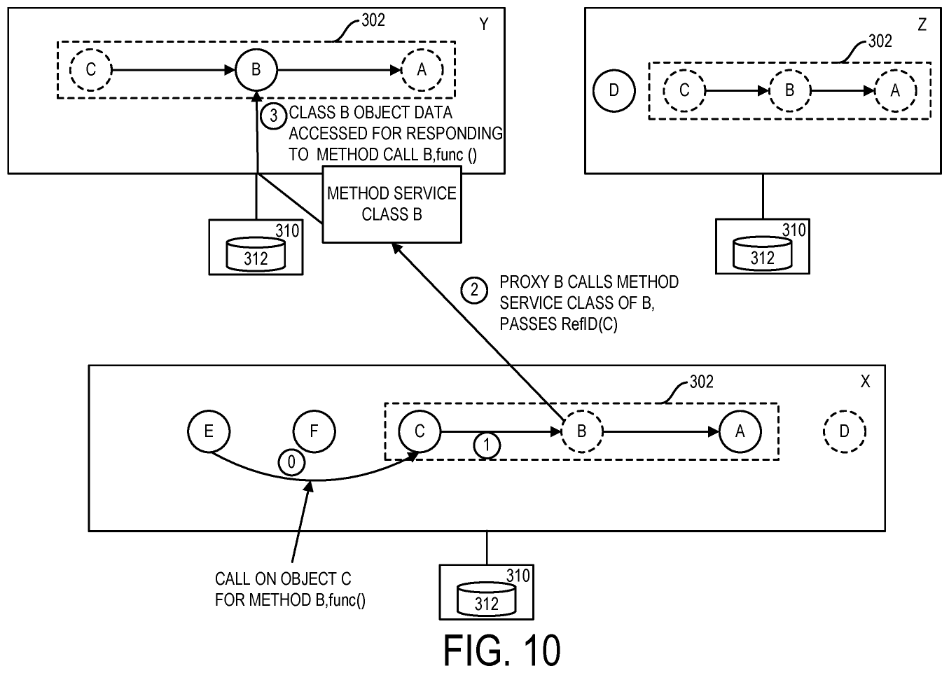

FIG. 10 depicts handling of a service call on an object of a constructed object of type C constructed as described in connection with FIG. 8, wherein the service call is a call for an inherited method of class B.

At (0), a call for the inherited type C object method B.func( ) inherited from class B can be sent to physical class C. On receipt of the call at (0), physical class C using object registry 312 of microservice partition X, can ascertain that the constructed object of type C constructed according to FIG. 8 is active and referenced to the reference identifier RefID(C). At (1), in response to receipt of the method call of (0), physical class C can call proxy class B within microservice partition X.

At (2) in response to the call of (1), proxy class B can call method service class B of microservice partition Y. With the call at (2), microservice partition X can pass to microservice partition Y the reference identifier for the constructed object of type C, namely the reference identifier RefID=RefID(C). At (3), in response to the receipt of the call at (2), method service class B can use the reference identifier for the constructed object of type C, RefID=RefID(C), received by microservice partition Y at (2) in order to access method defining object data and/or variable defining object data of class B, defining the object C method inherited from class B, referred to herein as B.func( ). Microservice partition Y can subsequently return result data to the call initiating microservice partition X.

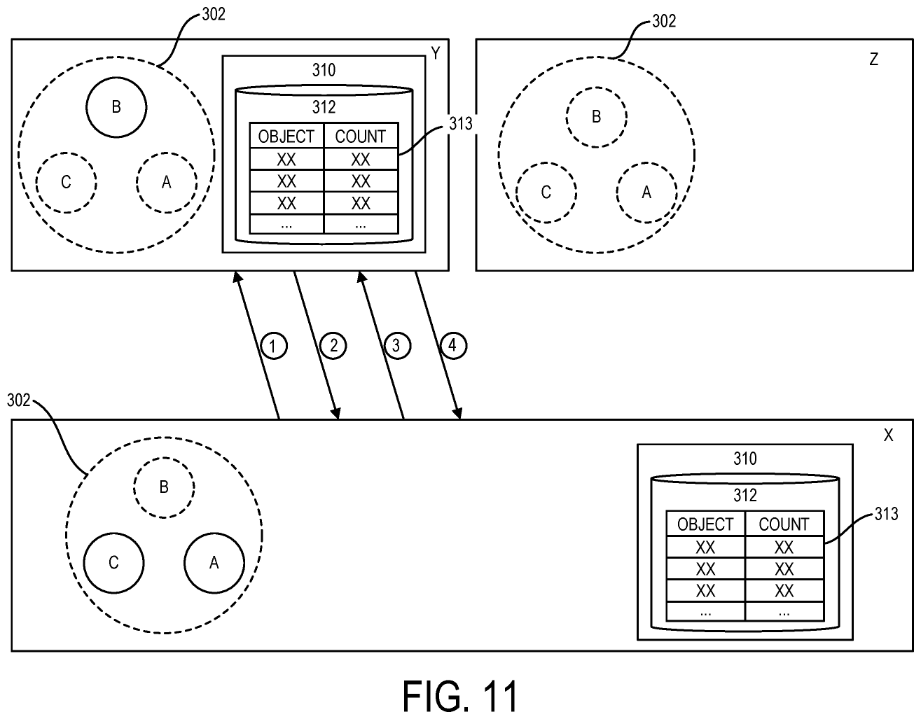

FIG. 11 depicts a garbage collection process according to one embodiment. According to a garbage collection process, each microservice partition that hosts one or more class of an inheritance chain of classes can maintain a remote reference counter 313 within object registry 312 of a respective partition manager 310. Remote reference counter 313 of respective object registries 312 can record a count of remote references to a constructed physical object, e.g., the described constructed object of type C identified by RefID=RefID(C).

In general, garbage collection can operate by maintaining a count of remote references to a physical object. The count can be incremented each time a new remote reference is created and decremented each a time a proxy object (that holds a remote reference) is garbage collected (using the standard JVM garbage collection mechanism). The count can be maintained by remote reference counter 313 the partition manager. A new remote reference can be created when a reference to a physical object in a partition is sent to another partition as a parameter of a service call. When the corresponding proxy object is created in the target partition (from a proxy class), the incrementer service can be called on a source partition where the object was constructed to increase the remote reference count for the object. When a proxy class is garbage collected in any partition, the decrementer service on the partition where the corresponding physical object was constructed can be called to decrement the remote reference count.

For distributed objects, the partition manager 310 of the initiator partition (where object construction starts) can maintain a remote reference count and can synchronize that count with the other partitions where a partial state of the object exists. During object construction, the remote reference count is set to 1 and propagated to the partition managers 310 of all partitions with partial object state so that counters 313 of microservice partitions holding a partial object state are synchronized to the same value. Whenever the incrementer or decrementer service of the initiator partition is called, it propagates the updated remote reference count to the partition managers 310 of all microservice partitions with partial object state. When remote reference count for an object becomes 0 in any partition, the respective partition manager 310 can remove that object from object registry 312 of the respective partition. In one use case, such an object can be one of the objects created to represent partial object state of a distributed object. Incrementer and decrementer services can be called in the distributed object scenario in the manner that they are called in the centralized object scenario.

A new remote reference can be created whenever a new proxy object is created in a partition corresponding to a physical object hosted in some other partition. A first call in which the object is constructed can result in the remote reference counter of an initiator partition (where object construction starts) to be initialized to 1, and remote reference counters 313 of other partitions holding a partial state of the constructed average can be synchronized to the same value of 1.

Embodiments herein recognize that in a monolithic JVM environment, a proxy object can be garbage collected by a JVM when the proxy object goes out of scope or there are no more live references to it. The JVM's garbage collector can implement algorithms for determining when an object can be garbage collected so that the memory allocated to it can be reclaimed.

Embodiments herein can include an incrementer/decrementer service for remote object references. Embodiments herein recognize that in the JVM environment, a finalizer method can be called at the point when an object is about to be garbage collected. In distributed microservice partition embodiments herein, finalizer methods in proxy classes can be configured to initiate calls to a decrementer service for decrementing one or more remote reference counter.

In one aspect, a remote reference counter can be incremented responsively to method calls that pass a remote reference to another partition, and which result in the creation of a new proxy object in the target partition. In one embodiment, a remote reference counter can be initialized to 1 when a first proxy object for a physical object is created in a microservice partition other than the microservice partition where the physical object occurs and is constructed. In one embodiment, a remote reference counter 313 can be incremented each time a new proxy object is created for a constructed physical object (which happens when remote references are passed across partitions via method calls).

Each time a proxy object is garbage collected by the JVM, the remote reference counter 313 of each microservice partition holding partial object state can be decremented (via call to decremented service in the finalizer method). In one embodiment, a first partition manager 310 having a remote reference counter 313 that is decremented can call partition managers 310 of remaining microservice partitions so that decrementing of all remote reference counters 313 of microservice partitions holding partial object state is synchronized. After all proxy objects have been garbage collected by the JVM, the remote reference counter 313 of each microservice partition holding a partial object state goes down to 0. When the remote reference counter 313 of each respective microservice partition holding a partial object state goes down to 0, partition manager 310 for garbage collection removes the object from the object registry 312 after which the allocated memory space 326 allocated to the referenced physical object (e.g., heap memory space) can be reclaimed by the JVM of the respective microservice partition.

According to aspects set forth herein, a JVM can implement garbage collection algorithms for determining when an object goes out of scope, and there are no live references to it, so that runtime memory allocated to the object can be reclaimed. Embodiments herein can be provided so that when a proxy object is garbage collected, a finalizer method of the object can be called by a JVM garbage collector, which in turn can call a decrementer service. When a remote reference (e.g., in the form of string data) is sent to a target microservice partition, a proxy object can be created from the string. When the proxy object is created, a remote reference counter for the corresponding physical object can be incremented.

Incrementer and decrementer services for a physical object can be provided in microservice partitions hosting a physical object. An incrementer service can be called from the constructor of a proxy object. The decrementer service can be called from the finalizer method of a proxy object. The finalizer method can be automatically called in the JVM during garbage collection. When a JVM determines that an object can be garbage collected, it can call the finalizer method of the object at that time. The finalizer method of a proxy object can include a call to the decrementer service.

Various aspects of distributed garbage collection are set forth in reference to FIG. 11. The call (0) described in FIG. 9 on class C within microservice partition X initiating the construction of the described object RefID=RefID(C) can alternatively originate from a constructor of proxy object C of the external partition W (not shown). The described object construction originating from microservice partition W (not shown) can include a constructor of the proxy object C in partition W calling an incrementer service of microservice partition X. With the incrementer service of microservice partition X, called partition manager 310 of microservice partition X incrementing remote reference counter 313 for object RefID=RefID(C) of microservice partition X by 1 to the value 1.

At (1) partition manager 310 of microservice partition X can call partition manager 310 of microservice partition Y to increment remote reference counter 313 for object RefID=RefID(C) of microservice partition Y to the value 1 so that the set of microservice partitions, microservice partition X and microservice partition Y holding object state for the object RefID=RefID(C) have counter values of remote reference counter 313 synchronized to the value 1.

Subsequently, with the object RefID=RefID(C) constructed as described in reference to FIG. 8, microservice partition X can send a remote reference for the object RefID=RefID(C) (e.g., in the form of string data) to target microservice partition Z for construction of proxy object C in microservice partition Z. The described construction of proxy object C in microservice partition Z can result in partition manager 310 of microservice partition Y incrementing remote reference counter 313 for object RefID=RefID(C) of microservice partition Y by 1 to the value 2, and at (2) partition manager 310 of microservice partition X can call partition manager 310 of microservice partition X to increment remote reference counter 313 for object RefID=RefID(C) of microservice partition X by 1 to the value 2 so that the set of microservice partitions, microservice partition X and microservice partition Y holding object state for the object RefID=RefID(C) have counter values of remote reference counter 313 for the object RefID=RefID(C) synchronized to the value 2.

Accordingly, there is set forth herein a method including constructing object data of a first class in the first microservice partition, and constructing object data of a second class in the second microservice partition, wherein the object data of the first class and the object data of the second class define a certain object, wherein the method includes incrementing a remote reference count for the certain object to a first value in the first microservice partition, and responsively to the incrementing the remote reference count for the certain object to the first value in the first microservice partition, calling, by the first microservice partition the second microservice partition, and responsively to the calling, incrementing a remote reference count for the certain object in the second microservice partition to the first value so that an object remote reference count for the certain object between the first microservice partition and the second microservice partition is synchronized.

Subsequently to the described remote reference count for the object RefID=RefID(C) being synchronized to the value 2, a criterion for garbage collection of the proxy object C of microservice partition W can be satisfied. Responsively, a finalizer method for proxy object C of microservice partition W can be called which can call a decrementer service of partition X.

With the decrementer service of microservice partition X called, partition manager 310 of microservice partition X can decrement remote reference counter 313 for object RefID=RefID(C) of microservice partition X by 1 to the value 1.

At (3) partition manager 310 of microservice partition X can call partition manager 310 of microservice partition Y to decrement remote reference counter 313 for object RefID=RefID(C) of microservice partition Y by 1 to the value 1 so that the set of microservice partitions, microservice partition X and microservice partition Y holding object state for the object RefID=RefID(C) have counter values of remote reference counter 313 for the object RefID=RefID(C) synchronized to 1.

Subsequently, a criterion for garbage collection of the proxy object C of microservice partition Z can be satisfied. Responsively, a finalizer method for proxy object C of microservice partition Z can be called which can call a decrementer service of partition Y.

With the decrementer service of microservice partition Y called, partition manager 310 of microservice partition Y can decrement remote reference counter 313 for object RefID=RefID(C) of microservice partition X by 1 to the value 0.

At (4) partition manager 310 of microservice partition Y can call partition manager 310 of microservice partition X to decrement remote reference counter 313 for object RefID=RefID(C) of microservice partition X by 1 so that the set of microservice partitions, microservice partition X and microservice partition Y holding object state for the object RefID=RefID(C) have counter values of remote reference counter 313 for the object RefID=RefID(C) synchronized to the value 0.

When the remote reference counter 313 of microservice partition Y holding a partial object state of object RefID=RefID(C) goes down to 0, partition manager 310 of microservice partition Y for garbage collection of the object RefID=RefID(C) can remove the object from the object registry 312 of microservice partition Y after which the JVM of the respective microservice partition Y for garbage collection of the object RefID=RefID(C) can reclaim the allocated memory space 326 of microservice partition Y allocated to the referenced physical object (e.g., heap memory space) for object data of object RefID=RefID(C).

When the remote reference counter 313 of microservice partition X holding a partial object state of object RefID=RefID(C) goes down to 0, partition manager 310 of microservice partition X for garbage collection of the object RefID=RefID(C) can remove the object from the object registry 312 of microservice partition X after which the JVM of the respective microservice partition X for garbage collection of the object RefID=RefID(C) can reclaim the allocated memory space 326 of microservice partition X allocated to the referenced physical object (e.g., heap memory space) for object data of object RefID=RefID(C).

Embodiments herein recognize that in a monolith application a Java virtual machine (JVM) can maintain a remote reference count for each created object. When the remote reference count for an object (number of active calls on an object) goes down to zero, the heap memory occupied by the object can be reclaimed by a garbage collector of the JVM.

Embodiments herein can simulate the described garbage collection behavior of a monolithic application in the distributed environment of the transformed application, where each microservice partition can have its own JVM instance running and an object created in a partition (that is, the JVM running in the partition) can have remote references in other partitions/JVMs (in addition to local references in the JVM where the physical object exists). In the described example of FIG. 11, the generated method service class for class A and class B can provide an “incrementer” API endpoint method for incrementing object remote reference count by one and a “decrementer” API endpoint method for decrementing object remote reference count by one for each object of type C defined by combination of class C object data, parent class B object data, and parent class A object data. The remote reference count for a physical object can be stored in each respective object remote reference counter 313 of the respective microservice partitions having runtime memories where object data defining the object of type C is stored. When a remote reference is created in another microservice partition/JVM, which occurs when a proxy object for object Cis created in that partition/JVM, the proxy class can call the incrementor API endpoint to increase the remote reference count for the respective physical object by one. The generated proxy class can implement a finalizer method (a finalizer method, if defined in a Java class, can be automatically called by the JVM when an instance of that class is about garbage collected): the finalizer method can call the decrementor API endpoint to decrease the object remote reference count by one.

Accordingly, whenever a proxy object (that is, a new remote reference) is created, the remote reference count for the physical object can be incremented, and whenever a proxy object is garbage collected, the remote reference count for the physical object can be decremented. In this way, the reference counting for objects that is performed implicitly by a JVM in a monolithic application can be performed explicitly for remote objects/references in the described distributed set of microservice partitions set forth herein. When the reference count for an object o stored in an object remote reference counter 313 of a partition manager 310 goes down to zero, it indicates that no remote references exist for o; therefore, partition manager 310 can remove o from the object registry. At this point, if there are no local references to o in the respective JVMs of each microservice partition hosting a physical class defining an inheritance chain of classes, o would be garbage collected by the JVM of each microservice partition hosting a physical class defining an inheritance chain of classes (partition X and Y in the described example of FIG. 11). The method, in this manner, ensures that the garbage-collection behavior of the monolith is preserved in the transformed application.

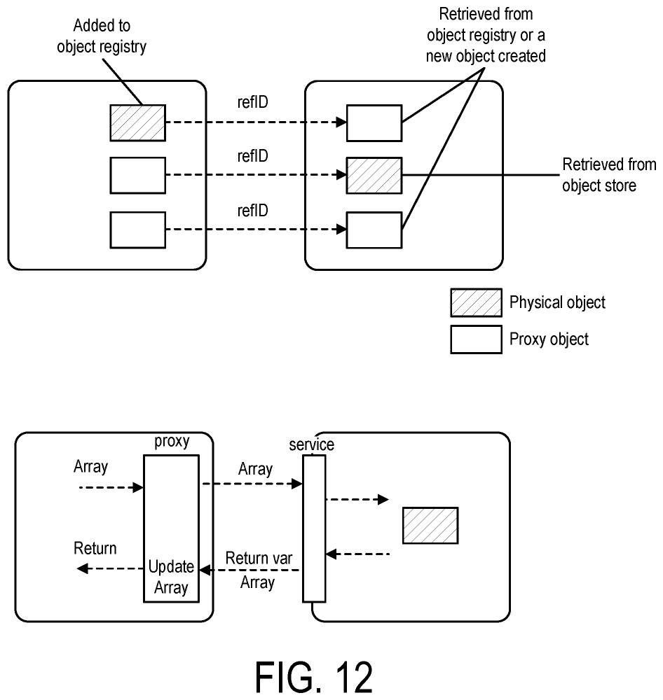

Referring to FIG. 12, multiple object identifiers can be passed between microservice partitions in the form of arrays. FIG. 12 illustrates parameter translation between caller and callee partitions. In one example, there can be a physical caller that calls a proxy object, physical object (caller)→proxy object (callee). In one example, there can be a proxy object that calls a physical object, proxy object (caller)→physical object (callee). In one example, there can be a proxy object that calls a proxy object, proxy object (caller)→proxy object (callee).

In one embodiment, translation can be performed based on a runtime type of parameter instead of a declared static type. Performing translation based on runtime type precisely handles different concrete types that a parameter with an overly general declared type (e.g., java.lang.Object) can take at runtime. In one embodiment, collection and map types can be converted to reference identifiers when sent across partitions to avoid replicated states. Arrays passed in as parameters can be subject to element changes such as add and remove. Changes can be preserved when a method returns to the caller but need not be explicitly declared in a return. Arrays passed as parameters can be handled by having a service class perform the return.

Embodiments herein provide methodology and solutions to transform enterprise object oriented applications into a set of stand-alone microservice partitions. The resulting microservice partitions can handle distributed object inheritance across multiple microservice partitions and can also handle dynamic creation, innovation, type conversion, and deletion of the distributed objects with inheritance. Embodiments herein can provide a distributed object management solution that is semantically equivalent to a centralized monolithic object oriented computer program runtime environment, e.g., as can be provided by a Java virtual machine (JVM), therefore preserving runtime semantics of the JVM in a distributed manner. As a result, monolith applications can be decoupled down to fine grained and standalone microservices for implementations such as hybrid cloud with minimal or no source code rewrite.

According to embodiments herein, execution of a constructor chain can invoke constructors in physical or proxy classes. A constructor chain execution initiated in a microservice partition can be replicated in each microservice partition that contains at least one physical class from the inheritance chain.

According to one embodiment, one globally unique reference identifier can be created to refer to all object fragments of an inheritance chain of objects created in different partitions during the execution of a constructor chain. The global reference identifier can be created in an initiating partition and propagated to all partitions with chain replications. The global reference identifier can be created in an initiating partition and propagated to all partitions in which object data has been constructed.

Proxy class shallow constructors can be automatically generated and added to each physical class, one such constructor corresponding to each declared constructor in the class. A proxy class shallow constructor (e.g., class B of microservice partition X in FIG. 8) can call a parent class's constructor without constructing object data for support of object method calls. In a physical class (e.g., class B of microservice partition Y in FIG. 8), a constructor can contain state initialization statements (i.e., copy of code in the corresponding normal constructor). In one embodiment, each constructor chain can contain invocations of shallow constructors in all classes except the chain initiator, and the invocations remain within the partition (i.e., no service calls occur).

Embodiments herein can include distributing a hierarchy of inherited classes across microservices such that a single class's attributes and method logic only reside in a single microservice. There is set forth herein, in one aspect, providing management solutions for the creation, invocation, and deletion of class instance with distributed inheritance across the microservices with the aid of proxy and service classes. There is set forth herein, in one aspect, a method for resolving type conversion of inherited class instances that results in semantically equivalent access to the right object attributes and states and invoke the right class methods that may reside in a different microservice. There is set forth herein, in one aspect, a method for management to account for system, native classes, and data structures (e.g., array).

Embodiments herein recognize inheritance is a commonly used solution in Java enterprise edition (JEE) applications, and the inability to cleanly separate the inherited classes directly attributes to the inability to refactor a monolith application into fine-grained services. Embodiments herein recognize that restricting classes defining inheritance chains to common partitions can create coarse partitions, each containing many classes and different functionalities. In degenerate cases, restricting classes defining inheritance chains to common partitions can create “monolithic partitions”. Embodiments herein recognize that restricting classes defining inheritance chains to common partitions can reduce the effectiveness of microservice decomposition. Embodiments herein can provide for distributing inheritance relations across partitions in a manner that preserves the semantics of centralized inheritance: i.e., with respect to object creation, constructor chaining, object state reads/updates, dynamic dispatch, reference parameter passing, and garbage collection. Embodiments herein can remove the constraint that, for functional equivalence, classes with an inheritance relation must occur in a common partition. Embodiments herein recognize that collocation may still be desirable for performance reasons for certain functions, but facilitates the distribution of classes defining an inheritance chain of classes across multiple microservice partitions.

According to one embodiment, one object's state can be split across multiple microservice partitions (JVMs), e.g., one JVM object ref→3 JVM object refs. Constructor chaining in a microservice partition can be replicated in other microservice partitions that the inheritance chain spans without duplicating object (sub)states. Each method can execute in the context of the microservice partition to which its declaring class belongs. According to aspects herein, a method can have access to the relevant concrete object (sub)state in that JVM. Object references can be passed across microservice partitions. In one aspect, passed references can be translated in a way that avoids duplicated object (sub)states.

In one embodiment, execution of a constructor chain can invoke constructors in physical or proxy classes. A constructor chain execution initiated in a microservice partition can be replicated in each microservice partition that hosts at least one physical class from an inheritance chain. In one embodiment, a single globally unique reference ID can be created to refer to all object fragments created in different microservice partitions during the execution of a constructor chain. In one embodiment, the global reference ID can be created in an initiating microservice partition and can be propagated to all microservice partitions with chain replications. Proxy class shallow constructors can be automatically generated and added to each physical class, one such constructor corresponding to each declared constructor in the class.

A proxy class shallow constructor can call a parent class's constructor without constructing object data. In a physical class, a constructor can contain state initialization statements (i.e., copy of code in the corresponding normal constructor).

Embodiments herein recognize that if instances of system or library classes are passed across partitions, risk can be incurred if the classes are serialized on the caller side and deserialized on the callee side. Serialization and deserialization, while advantageous in some use cases, can result in multiple copies of an object (in different JVMs) and is not semantics preserving under these conditions. In a monolith, the callee's updates can be visible to the caller, whereas after serialization and deserialization in the transformed distributed microservices version employing serialization and deserialization, the updates happen on a different object instance (in the callee JVM) not visible to the caller and, thus, possibly changing the caller's behavior.

Embodiments herein can include passing an object by reference wherein the object can be a mutable type. Embodiments herein can include a callee updating the object state. A caller can feature data dependence on the state updated by the callee.

Embodiments herein can create service and proxy wrappings for system classes whose instances are passed across partitions. Embodiments herein can add instances of such classes to an object registry of the partition in which they are created, generating reference identifiers (remote references) for them. Embodiments herein can pass reference identifiers across partitions instead of physical objects. Embodiments herein can make service calls to the microservice partition owning and hosting object data defining a system object when methods are called on the object via remote references in other microservice partitions.

Embodiments herein can include inputting a hierarchy of inherited classes, and freely distributing the classes across microservice partitions such that a single class's variable and methods only resides in a single microservice partition of the set of microservice partitions. Embodiments herein can include creating management solutions for the creation, invocation, and deletion of class instances with distributed inheritance across a set of microservice partitions with the aid of proxy and service classes. Embodiments herein can include resolving type conversion of inherited class instances that results in semantically equivalent access to the correct object attributes and states and invokes the correct class methods that may reside in a different microservice partition. Embodiments herein can provide management to account for system, native classes, and data structures (e.g., array).

Embodiments herein can provide methodology and solutions to transform enterprise object oriented applications into a set of standalone microservice partitions. The resulting set of microservice partitions can handle distributed object inheritance across multiple microservice partitions and can also handle dynamic creation, innovation, type conversion, and deletion of the distributed objects with inheritance. Embodiments herein can provide a distributed object management solution that is semantically equivalent to a centralized JVM, therefore preserving runtime semantics of the JVM in a distributed manner. As a result, monolith applications can be decoupled down to fine grained and standalone microservice partitions for hybrid cloud with minimal source code rewrite.

Embodiments herein can include execution of a constructor chain that invokes constructors in physical or proxy classes. A constructor chain execution initiated in a microservice partition can be replicated in each microservice partition that hosts at least one physical class from the inheritance chain. One globally unique reference identifier can be created to refer to all object fragments created in different microservice partitions during the execution of a constructor chain. The global reference identifier can be created in the initiating microservice partition and propagated to one or more remaining microservice partition with chain replications.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. The computer implemented method also includes examining a monolithic object oriented computer program, where the monolithic object oriented computer program includes identifying that the monolithic object oriented computer program includes an inheritance chain of classes having a first class and a second class; and generating a distributed set of microservice partitions in dependence on the examining, where the generating includes performing the generating so that there is hosted in a first microservice partition of a distributed set of microservice partitions the first class and further so that there is hosted in a second microservice partition of the distributed set of microservices the second class. Other embodiments of this aspect include corresponding computer systems, apparatus, and computer programs recorded on one or more computer storage devices, each configured to perform the actions of the methods.

Implementations may include one or more of the following features. The computer implemented method where the method includes constructing object data of the first class in the first microservice partition. The method includes constructing object data of the first class in the first microservice partition, the constructing including allocating memory space of a runtime memory of the first microservice partition to the object data of the first class, and writing the object data to the allocated memory space of the runtime memory of the first microservice partition, where the method includes storing reference identifier for the object data of the first class in an object registry of the first microservice partition. The method includes constructing object data of the first class in the first microservice partition, the constructing including allocating memory space of a runtime memory of the first microservice partition to the object data of the first class, and writing the object data of the first class to the allocated memory space of the runtime memory of the first microservice partition, where the method includes storing a reference identifier for the object data of the first class in an object registry of the first microservice partition, and where the method includes sharing the reference identifier with the second microservice partition. The method includes constructing object data of the first class in the first microservice partition, the constructing including allocating memory space of working memory of the first microservice partition to the object data of the first class, and writing the object data to the allocated memory space, where the method includes storing reference identifier for the object data of the first class in an object registry of the first microservice partition, where the method includes sharing the reference identifier with the second microservice partition, constructing object data of the second class on the second partition, and assigning the reference identifier to the object data of the second class, where the object data of the first class and the object data of the second class define an object of the first class. The method includes constructing object data of the first class in the first microservice partition, and constructing object data of the second class in the second microservice partition, where the object data of the first class and the object data of the second class define an object of the first class. The method includes, in response to a call for construction of an object of the first class, constructing object data of the first class in the first microservice partition, and constructing object data of the second class in the second microservice partition, where the object data of the first class and the object data of the second class define the object of the first class. The method includes, in response to a call for construction of an object of the first class, constructing object data of the first class in the first microservice partition, and constructing object data of the second class in the second microservice partition, where the object data of the first class and the object data of the second class define the object of the first class, where the method includes receiving, within the first microservice partition a call on the object of the first class for an inherited method inherited from the second class, and responding to the call using the object data of the second class. The method includes constructing object data of the first class in the first microservice partition, constructing object data of the second class in the second microservice partition, and constructing object data of a third class in the first microservice partition, where the object data of the first class, the object data of the second class, and the object data of the third class define a certain object, where the method includes for construction of the certain object, (a) a constructor of the first class within the first microservice partition constructing the object data of the first class and calling a proxy class constructor of the second class within the first microservice partition, (b) the proxy class constructor, without constructing object data, calling a constructor of the third class within the first microservice partition, and (c) the constructor of the third class constructing the object data of the third class. The method includes constructing object data of the first class in the first microservice partition, and constructing object data of the second class in the second microservice partition, where the object data of the first class and the object data of the second class define a certain object, where the constructing of the object data of the first class includes allocating memory space of a runtime memory of the first microservice partition to the object data of the first class and writing the object data of the first class to the allocated memory space of the runtime memory of the first microservice partition, where the method includes assigning a reference identifier to the object data of the first class and sharing the reference identifier with the second microservice partition, where the constructing object data of the second class in the second microservice partition includes allocating memory space of a runtime memory of the second microservice partition to the object data of the second class and writing the object data of the second class to the allocated memory space of the runtime memory of second microservice partition, where the method includes assigning the reference identifier shared from the first microservice partition to the second microservice partition, to the object data of the second class, where the first microservice partition and the second microservice partition include respective application programming interfaces (APIs), where the runtime memory of the first microservice partition is defined on a first memory device of a first physical computing node, where the runtime memory of the second microservice partition is defined on a second memory device of a second physical computing node. Implementations of the described techniques may include hardware, a method or process, or computer software on a computer-accessible medium.

The computer implemented method also includes constructing object data of a first class in a first microservice partition; and constructing object data of a second class in a second microservice partition, where the second class and the first class are in inheritance class relation. Other embodiments of this aspect include corresponding computer systems, apparatus, and computer programs recorded on one or more computer storage devices, each configured to perform the actions of the methods.

Implementations may include one or more of the following features. The computer implemented method where the constructing of the object data of the second class is responsive to the constructing of the object data of the first class. The constructing of the object data of the second class is responsive to the constructing of the first class, where responsive to the constructing of the object data of the first class, a constructor of the first class calls the second microservice partition for construction of the object data of the second class. The constructing of the object data of the second class is responsive to the constructing of the object data of first class, where responsive to the constructing of the object data of the first class, a constructor of the first class calls the second microservice partition for construction of the object data of the second class, where the object data of the second class includes variable defining object data and method defining object data. The constructing of the object data of the first class includes allocating memory space of a runtime memory of the first microservice partition to the object data of the first class and writing the object data of the first class to the allocated memory space of the runtime memory of the first microservice partition, where the method includes assigning a reference identifier to the object data of the first class and sharing the reference identifier with the second microservice partition, where the constructing object data of the second class in the second microservice partition includes allocating memory space of a runtime memory of the second microservice partition to the object data of the second class and writing the object data of the second class to the allocated memory space of the runtime memory of second microservice partition, where the method includes assigning the reference identifier shared from the first microservice partition to the second microservice partition, to the object data of the second class, where the first microservice partition and the second microservice partition include respective application programming interfaces (APIs), where the runtime memory of the first microservice partition is defined on a first memory device of a first physical computing node, where the runtime memory of the second microservice partition is defined on a second memory device of a second physical computing node. The method includes responsively to the constructing of the object data of the first class in the first microservice partition, constructing the object data of the second class in the second microservice partition, and subsequently to the constructing of the object of the second class in the second microservice partition, receiving a service call by an object defined by the first object data and the second object data and responding to the service call using the object data of the second class. Implementations of the described techniques may include hardware, a method or process, or computer software on a computer-accessible medium.

The computer implemented method also includes receiving, by a certain class hosted on a first microservice partition, a call for construction of an object of the certain class, where the certain class is a child class of a parent class: in response to the receiving, constructing object data of the certain class on the first microservice partition and sending by the first microservice partition to a second microservice partition a call for construction of object data of the parent class; and constructing object data of the parent class on the second microservice partition in response to the call for construction of object data of the parent class, where the object of the certain class is defined by the object data of the certain class, and object data of the parent class. Other embodiments of this aspect include corresponding computer systems, apparatus, and computer programs recorded on one or more computer storage devices, each configured to perform the actions of the methods.

Implementations may include one or more of the following features. The computer implemented method where the method includes receiving by the object a call for an object method inherited from the parent class, and where the method includes responding to the call using the object data of the parent class. The method includes in response to the constructing of the object data of the certain class, assigning a reference identifier to the object data of the certain class. The method includes in response to the constructing the object data of the certain class, assigning a reference identifier for the object data of the certain class, and passing the reference identifier to the second microservice partition. The method includes in response to the constructing the object data of the certain class, assigning a reference identifier for the object data of the certain class, passing the reference identifier to the second microservice, and assigning the reference identifier to the object data of the parent class. The method includes in response to the constructing assigning a reference identifier for the object data of the certain class, passing the reference identifier to the second microservice partition, assigning the reference identifier to the object data of the parent class, receiving at the first microservice partition a call for a method of the certain object inherited from the parent class, and responding to the call for the method of the certain object inherited from the parent class using the reference identifier to access the object data of the parent class constructed on the second microservice partition. Implementations of the described techniques may include hardware, a method or process, or computer software on a computer-accessible medium.

Certain embodiments herein may offer various technical computing advantages involving computing advantages to address problems arising in the realm of computer networks. Embodiment herein can include examining a monolithic object oriented computer program, wherein the examining the monolithic object oriented computer program includes identifying that the monolithic object oriented computer program includes an inheritance chain of classes having a first class and a second class; and generating a distributed set of microservice partitions in dependence on the examining the monolithic object oriented computer program, wherein the generating the distributed set of microservice partitions includes performing the generating so that there is hosted in a first microservice partition of a distributed set of microservice partitions the first class and further so that there is hosted in a second microservice partition of the distributed set of microservices the second class. Embodiments herein can also include constructing object data of a first class in a first microservice partition; and constructing object data of a second class in a second microservice partition, wherein the second class and the first class are in inheritance class relation. Embodiments herein can also include receiving, by a certain class hosted on a first microservice partition, a call for construction of an object of the certain class, wherein the certain class is a child class of a parent class: in response to the receiving, constructing object data of the certain class on the first microservice partition and sending by the first microservice partition to a second microservice partition a call for construction of object data of the parent class; and constructing object data of the parent class on the second microservice partition in response to the call for construction of object data of the parent class, wherein the object of the certain class is defined by the object data of the certain class, and object data of the parent class. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

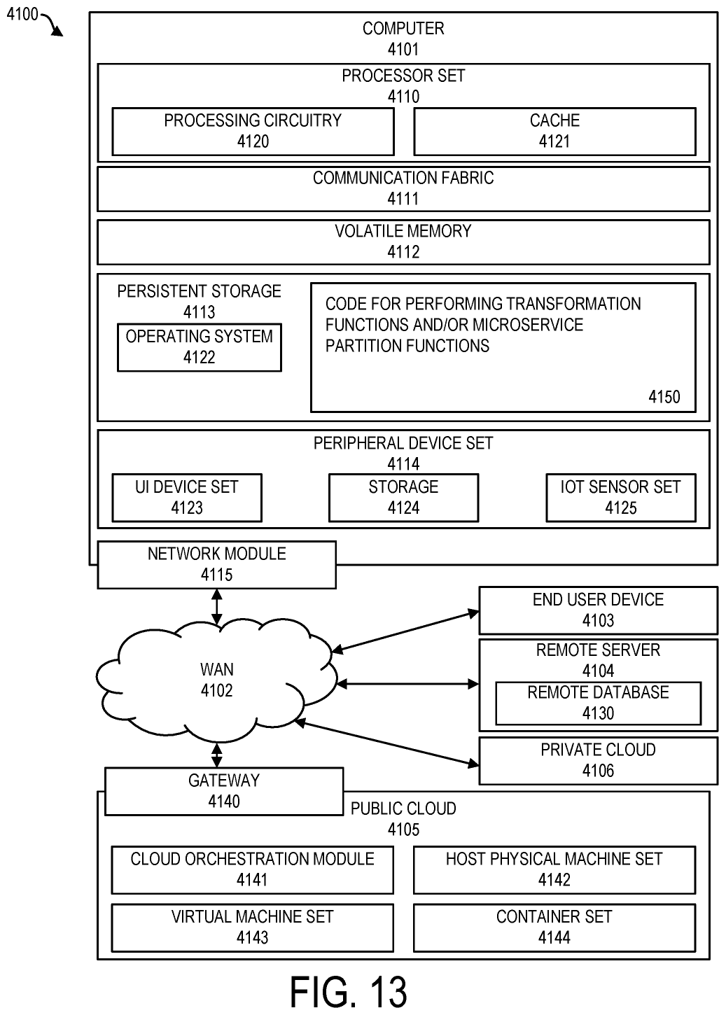

In reference to FIG. 13 there is set forth a description of a computing environment 4100 that can include one or more computer 4101. In one example, computing node 10 as set forth herein can be provided in accordance with computer 4101 as set forth in FIG. 13.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 13. In one aspect, a computing environment 4100 contains an example of an environment for the execution of at least some of the computer code involved in performing the inventive methods, such as code 4150 for performing transformation functions and/or microservice partition functions described with reference to FIGS. 1-12. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
examining a monolithic object oriented computer program, wherein the examining the monolithic object oriented computer program includes identifying that the monolithic object oriented computer program includes an inheritance chain of classes having a first class and a second class; and
generating a distributed set of microservice partitions in dependence on the examining the monolithic object oriented computer program, wherein the generating the distributed set of microservice partitions includes performing the generating so that there is hosted in a first microservice partition of a distributed set of microservice partitions the first class and further so that there is hosted in a second microservice partition of the distributed set of microservices the second class.

2. The computer implemented method of claim 1, wherein the method includes constructing object data of the first class in the first microservice partition.

3. The computer implemented method of claim 1, wherein the method includes constructing object data of the first class in the first microservice partition, the constructing including allocating memory space of a runtime memory of the first microservice partition to the object data of the first class, and writing the object data to the allocated memory space of the runtime memory of the first microservice partition, wherein the method includes storing reference identifier for the object data of the first class in an object registry of the first microservice partition.

4. The computer implemented method of claim 1, wherein the method includes constructing object data of the first class in the first microservice partition, the constructing including allocating memory space of a runtime memory of the first microservice partition to the object data of the first class, and writing the object data of the first class to the allocated memory space of the runtime memory of the first microservice partition, wherein the method includes storing a reference identifier for the object data of the first class in an object registry of the first microservice partition, and wherein the method includes sharing the reference identifier with the second microservice partition.

5. The computer implemented method of claim 1, wherein the method includes constructing object data of the first class in the first microservice partition, the constructing including allocating memory space of working memory of the first microservice partition to the object data of the first class, and writing the object data to the allocated memory space, wherein the method includes storing reference identifier for the object data of the first class in an object registry of the first microservice partition, wherein the method includes sharing the reference identifier with the second microservice partition, constructing object data of the second class on the second partition, and assigning the reference identifier to the object data of the second class, wherein the object data of the first class and the object data of the second class define an object of the first class.

6. The computer implemented method of claim 1, wherein the method includes constructing object data of the first class in the first microservice partition, and constructing object data of the second class in the second microservice partition, wherein the object data of the first class and the object data of the second class define an object of the first class.

7. The computer implemented method of claim 1, wherein the method includes, in response to a call for construction of an object of the first class, constructing object data of the first class in the first microservice partition, and constructing object data of the second class in the second microservice partition, wherein the object data of the first class and the object data of the second class define the object of the first class.

8. The computer implemented method of claim 1, wherein the method includes, in response to a call for construction of an object of the first class, constructing object data of the first class in the first microservice partition, and constructing object data of the second class in the second microservice partition, wherein the object data of the first class and the object data of the second class define the object of the first class, wherein the method includes receiving, within the first microservice partition a call on the object of the first class for an inherited method inherited from the second class, and responding to the call using the object data of the second class.

9. The computer implemented method of claim 1, wherein the method includes constructing object data of the first class in the first microservice partition, and constructing object data of the second class in the second microservice partition, wherein the object data of the first class and the object data of the second class define a certain object, wherein the method includes incrementing a remote reference count for the certain object to a first value in the first microservice partition, and responsively to the incrementing the remote reference count for the certain object to the first value in the first microservice partition, calling, by the first microservice partition the second microservice partition, and responsively to the calling, incrementing a remote reference count for the certain object in the second microservice partition to the first value so that an object remote reference count for the certain object between the first microservice partition and the second microservice partition is synchronized.

10. The computer implemented method of claim 1, wherein the method includes constructing object data of the first class in the first microservice partition, constructing object data of the second class in the second microservice partition, and constructing object data of a third class in the first microservice partition, wherein the object data of the first class, the object data of the second class, and the object data of the third class define a certain object, wherein the method includes, for construction of the certain object, (a) a constructor of the first class within the first microservice partition constructing the object data of the first class and calling a proxy class constructor of the second class within the first microservice partition, (b) the proxy class constructor, without constructing object data, calling a constructor of the third class within the first microservice partition, and (c) the constructor of the third class constructing the object data of the third class.

11. The computer implemented method of claim 1, wherein the method includes constructing object data of the first class in the first microservice partition, and constructing object data of the second class in the second microservice partition, wherein the object data of the first class and the object data of the second class define a certain object, wherein the constructing of the object data of the first class includes allocating memory space of a runtime memory of the first microservice partition to the object data of the first class and writing the object data of the first class to the allocated memory space of the runtime memory of the first microservice partition, wherein the method includes assigning a reference identifier to the object data of the first class and sharing the reference identifier with the second microservice partition, wherein the constructing object data of the second class in the second microservice partition includes allocating memory space of a runtime memory of the second microservice partition to the object data of the second class and writing the object data of the second class to the allocated memory space of the runtime memory of second microservice partition, wherein the method includes assigning the reference identifier shared from the first microservice partition to the second microservice partition, to the object data of the second class, wherein the first microservice partition and the second microservice partition include respective application programming interfaces (APIs), wherein the runtime memory of the first microservice partition is defined on a first memory device of a first physical computing node, wherein the runtime memory of the second microservice partition is defined on a second memory device of a second physical computing node, wherein the method includes incrementing a remote reference count for the certain object to a first value in the first microservice partition, and responsively to the incrementing the remote reference count for the certain object to the first value in the first microservice partition, calling, by the first microservice partition the second microservice partition, and responsively to the calling, incrementing a remote reference count for the certain object in the second microservice partition to the first value so that an object remote reference count for the certain object between the first microservice partition and the second microservice partition is synchronized, wherein the incrementing the remote reference count for the certain object to the first value in the first microservice partition is based on a call from a constructor of a proxy object for the certain object from a third microservice partition, wherein the method includes incrementing the remote reference count for the certain object from the first value to a second value in the first microservice partition based on passing of a reference to the certain object to a first microservice partition of construction of a proxy object of the certain object in the fourth microservice partition, wherein the method includes decrementing the count for the certain object in the first microservice partition to zero and responsively to the count for the certain object in the first microservice partition reaching zero reclaiming the allocated memory space of the runtime memory of the first microservice partition for garbage collection of the certain object.

12. A computer implemented method comprising:
constructing object data of a first class in a first microservice partition; and
constructing object data of a second class in a second microservice partition, wherein the second class and the first class are in inheritance class relation.

13. The computer implemented method of claim 12, wherein the constructing of the object data of the second class is responsive to the constructing of the object data of the first class.

14. The computer implemented method of claim 12, wherein the constructing of the object data of the second class is responsive to the constructing of the first class, wherein responsive to the constructing of the object data of the first class, a constructor of the first class calls the second microservice partition for construction of the object data of the second class.

15. The computer implemented method of claim 12, wherein the constructing of the object data of the second class is responsive to the constructing of the object data of first class, wherein responsive to the constructing of the object data of the first class, a constructor of the first class calls the second microservice partition for construction of the object data of the second class, wherein the object data of the second class includes variable defining object data and method defining object data.

16. The computer implemented method of claim 12, wherein the constructing of the object data of the first class includes allocating memory space of a runtime memory of the first microservice partition to the object data of the first class and writing the object data of the first class to the allocated memory space of the runtime memory of the first microservice partition, wherein the method includes assigning a reference identifier to the object data of the first class and sharing the reference identifier with the second microservice partition, wherein the constructing object data of the second class in the second microservice partition includes allocating memory space of a runtime memory of the second microservice partition to the object data of the second class and writing the object data of the second class to the allocated memory space of the runtime memory of second microservice partition, wherein the method includes assigning the reference identifier shared from the first microservice partition to the second microservice partition, to the object data of the second class, wherein the first microservice partition and the second microservice partition include respective application programming interfaces (APIs), wherein the runtime memory of the first microservice partition is defined on a first memory device of a first physical computing node, wherein the runtime memory of the second microservice partition is defined on a second memory device of a second physical computing node.

17. The computer implemented method of claim 12, wherein the method includes responsively to the constructing of the object data of the first class in the first microservice partition, constructing the object data of the second class in the second microservice partition, and subsequently to the constructing of the object of the second class in the second microservice partition, receiving a service call by an object defined by the first object data and the second object data and responding to the service call using the object data of the second class.

18. A computer implemented method comprising:
receiving, by a certain class hosted on a first microservice partition, a call for construction of an object of the certain class, wherein the certain class is a child class of a parent class;
in response to the receiving, constructing object data of the certain class on the first microservice partition and sending, by the first microservice partition, to a second microservice partition a call for construction of object data of the parent class; and
constructing object data of the parent class on the second microservice partition in response to the call for construction of object data of the parent class, wherein the object of the certain class is defined by the object data of the certain class and object data of the parent class.

19. The computer implemented method of claim 18, wherein the method includes receiving, by the object, a call for an object method inherited from the parent class, and wherein the method includes responding to the call using the object data of the parent class.

20. The computer implemented method of claim 18, wherein the method includes in response to the constructing of the object data of the certain class, assigning a reference identifier to the object data of the certain class.

21. The computer implemented method of claim 18, wherein the method includes in response to the constructing the object data of the certain class, assigning a reference identifier for the object data of the certain class, and passing the reference identifier to the second microservice partition.

22. The computer implemented method of claim 18, wherein the method includes in response to the constructing the object data of the certain class, assigning a reference identifier for the object data of the certain class, passing the reference identifier to the second microservice, and assigning the reference identifier to the object data of the parent class.

23. The computer implemented method of claim 18, wherein the method includes in response to the constructing assigning a reference identifier for the object data of the certain class, passing the reference identifier to the second microservice partition, assigning the reference identifier to the object data of the parent class, receiving at the first microservice partition a call for a method of the certain object inherited from the parent class, and responding to the call for the method of the certain object inherited from the parent class using the reference identifier to access the object data of the parent class constructed on the second microservice partition.

24. A computer program product comprising:
a computer readable storage medium readable by one or more processing circuit and storing instructions for execution by one or more processor for performing a method comprising:
examining a monolithic object oriented computer program, wherein the examining the monolithic object oriented computer program includes identifying that the monolithic object oriented computer program includes an inheritance chain of classes having a first class and a second class; and
generating a distributed set of microservice partitions in dependence on the examining the monolithic object oriented computer program, wherein the generating the distributed set of microservice partitions includes performing the generating so that there is hosted in a first microservice partition of a distributed set of microservice partitions the first class and further so that there is hosted in a second microservice partition of the distributed set of microservices the second class.

25. A system comprising:
a memory;
at least one processor in communication with the memory; and
program instructions executable by one or more processor via the memory to perform a method comprising:
examining a monolithic object oriented computer program, wherein the examining the monolithic object oriented computer program includes identifying that the monolithic object oriented computer program includes an inheritance chain of classes having a first class and a second class; and
generating a distributed set of microservice partitions in dependence on the examining the monolithic object oriented computer program, wherein the generating the distributed set of microservice partitions includes performing the generating so that there is hosted in a first microservice partition of a distributed set of microservice partitions the first class and further so that there is hosted in a second microservice partition of the distributed set of microservices the second class.
